(19) United States
(12) Patent Application Publication
(10) Pub. No.: US 2009/0063797 A1
(43) Pub. Date: Mar. 5, 2009

(54) BACKUP DATA ERASURE METHOD

(76) Inventors: Yuichi Taguchi, Sagamihara (JP); Masayuki Yamamoto, Sagamihara (JP); Hiroshi Nasu, Yokohama (JP); Noriko Nakajima, Machida (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/030,545

(22) Filed: Feb. 13, 2008

(30) Foreign Application Priority Data
Sep. 5, 2007 (JP) 2007-230337

(51) Int. Cl. G06F 12/00

(52) U.S. Cl. 711/162; 711/E12.001

(57) ABSTRACT

A computer system comprises a storage subsystem, a host computer and a management computer, and stores catalogue information containing correspondence between a first volume for data reading or writing and a second volume for storing a copy of the data stored in the first volume. The management computer requests the storage subsystem to erase the data stored in the first volume upon reception of an erasure request of the data stored in the first volume. The storage subsystem erases the data stored in the first volume. The management computer specifies a second volume for storing the copy of the data stored in the first volume based on the catalogue information. The storage subsystem erases data stored in the specified second volume. Thus, security risks are reduced by erasing data regarding the data when the data stored in the volume is erased.

### CLAIM OF PRIORITY

The present application claims priority from Japanese patent application JP 2007-230337 filed on Sep. 5, 2007, the content of which is hereby incorporated by reference into this application.

### BACKGROUND

This invention relates to a technology of erasing data stored in a storage subsystem, and more particularly, to a technology of erasing a copy of data of an erasure target.

A storage area network (SAN) for connecting at least one external storage device with at least one computer has been known. The storage area network is especially useful when a plurality of computers share one large storage device. A storage system that includes such a storage area network has high extendability because a storage device or a computer can be easily added thereto and eliminated therefrom.

For the external storage device connected to the SAN, a disk array device is generally used. The disk array device is a device on which many storage devices (such as magnetic disk drives) represented by hard disks are mounted.

The disk array device manages several magnetic disk drives as one group of redundant array of independent disks (RAID) by a RAID technology. The RAID group forms at least one logical storage areas. The computer connected to the SAN executes a data I/O process in the storage area. The disk array device records redundant data in the magnetic disk drive of the RAID group when data is recorded in the storage area. Data can be restored from the redundant data even when one of the magnetic disk drives fails.

A storage area of an erasure target is overwritten with dummy data to erase the data recorded in the magnetic disk drive. However, when the overwriting of dummy data is carried out only once, restoration of data may be allowed because of residual magnetism. Thus, a technology of completely erasing residual magnetism by repeating dummy data overwriting at least three or more times has been disclosed (refer to JP 2007-11522 A). Security risks can be reduced by completely erasing the residual magnetism to prevent data restoration.

A storage system that includes a plurality of logical devices and a juke box system for setting one of the plurality of logical devices as a computer access target has recently been proposed. The juke box system can change the logical device of the access target according to a request from a management computer (refer to JP 2005-209149 A). The change of the logical device of the access target enables storage of a copy of data at the time of changing, thereby permitting generation management of the copy of the data.

A magnetic disk medium (hard disk drive) has widely been used for storing data. The data recorded in the magnetic disk medium has a characteristic that it is restorable, because it is not completely erased through a simple file erasure operation or a volume formatting process. Especially because of magnetic disk characteristics, residual magnetism may remain on the medium, causing data restoration, when data overwriting is carried out only once, or after the formatting process.

A recent growing concern about security has been accompanied by a demand for a technology of completely erasing stored data. Therefore, a complete erasure process that repeats dummy data overwriting a plurality of times is useful for completely removing the residual magnetism from the magnetic disk.

On the other hand, even if the data stored in the storage device is completely erased, when backup data is stored, the data may leak from the backup data. Erasure of data may become difficult especially when management of backup data generated in the past is insufficient.

Moreover, in a case of creating a backup of the data of the magnetic disk drive in the magnetic disk drive, even when a source data area is overwritten a plurality of times to completely erase data, and replaced by zero data, overwriting is carried out only once in a destination data area if the zero data is only copied to a destination disk. As a result, residual magnetism remains, creating a possibility of data restoration.

### SUMMARY

A representative aspect of this invention is as follows. That is, there is provided a computer system comprising: a storage subsystem; a host computer coupled to the storage subsystem via a network; and a management computer having access to the storage subsystem and the host computer. The storage subsystem comprises a first interface coupled to the network, a first processor coupled to the first interface, and a first memory coupled to the first processor, and provides a first volume for reading/writing data to the host computer. The management computer comprises a second interface coupled to the network, a second processor coupled to the second interface, and a second memory coupled to the second processor. The computer system stores catalogue information including correspondence between the first volume and a second volume for storing a copy of data stored in the first volume. The management computer requests erasure of the data stored in the first volume to the storage subsystem upon reception of an erasure request of data stored in the first volume. The storage subsystem erases the data stored in the first volume based on the erasure request of the data stored in the first volume. The management computer specifies the second volume storing a copy of the data stored in the first volume based on the catalogue information, and requests erasure of data stored in the specified second volume to the storage subsystem. The storage subsystem erases the data stored in the specified second volume.

According to the aspect of this invention, security risks can be reduced by further erasing the copy (backup or archive) of the erased data when the data stored in the storage area is erased.

### BRIEF DESCRIPTION OF THE DRAWINGS

The present invention can be appreciated by the description which follows in conjunction with the following figures, wherein:

FIG. 1 is a block diagram showing a configuration of a storage area network in accordance with a first embodiment of this invention;

FIG. 2 is a block diagram showing a configuration of a storage subsystem in accordance with the first embodiment of this invention;

FIG. 3 is a block diagram showing a configuration of a host computer in accordance with the first embodiment of this invention;

FIG. 4 is a block diagram showing a configuration of a management computer in accordance with the first embodiment of this invention;

FIG. 5 is a block diagram showing a configuration of a configuration of a control program and control information stored in a program memory of the storage subsystem in accordance with the first embodiment of this invention;

FIG. 6 is a block diagram showing a configuration of a control program and control information stored in a program memory of the management computer in accordance with the first embodiment of this invention;

FIG. 7 is an explanatory diagram showing an example of RAID group configuration information stored in the storage subsystem in accordance with the first embodiment of this invention;

FIG. 8 is an explanatory diagram showing an example of storage area configuration information stored in the storage subsystem in accordance with the first embodiment of this invention;

FIG. 9 is an explanatory diagram showing an example of logical unit configuration information stored in the storage subsystem in accordance with the first embodiment of this invention;

FIG. 10 is an explanatory diagram showing an example of copy configuration information stored in the storage subsystem in accordance with the first embodiment of this invention;

FIG. 11 is an explanatory diagram showing an example of update data information stored in the storage subsystem in accordance with the first embodiment of this invention;

FIG. 12 is an explanatory diagram showing an example of copy data catalogue information stored in the management computer in accordance with the first embodiment of this invention;

FIG. 13 is a flowchart showing a procedure of updating configuration information of the storage subsystem stored in the management computer in accordance with the first embodiment of this invention;

FIG. 14 is a flowchart showing a data erasure processing procedure of a storage area in accordance with the first embodiment of this invention;

FIG. 15 is a flowchart showing a data erasure processing procedure of a storage area in accordance with the first embodiment of this invention;

FIG. 16 is a flowchart showing a data erasure processing procedure of a storage area in accordance with the first embodiment of this invention;

FIG. 17 is an explanatory diagram showing an output example of an erasure certificate in accordance with the first embodiment of this invention;

FIG. 18 is an explanatory diagram showing a copy configuration of the storage subsystem in accordance with the first embodiment of this invention;

FIG. 19 is a block diagram showing a configuration of a configuration of a control program and control information stored in a program memory of the storage subsystem in accordance with a second embodiment of this invention;

FIG. 20 is a block diagram showing a configuration of a control program and control information stored in a program memory of the management computer in accordance with the second embodiment of this invention;

FIG. 21 is an explanatory diagram showing an example of storage area catalogue management information stored in the management computer in accordance with the second embodiment of this invention;

FIG. 22 is a flowchart showing a data erasure processing procedure of a storage area in accordance with the second embodiment of this invention;

FIG. 23 is a block diagram showing a configuration of a tape library device in accordance with a third embodiment of this invention;

FIG. 24 is a block diagram showing a configuration of a configuration of a control program and control information stored in a program memory of the storage subsystem in accordance with the third embodiment of this invention;

FIG. 25 is a block diagram showing a configuration of a control program and control information stored in a program memory of the management computer in accordance with the third embodiment of this invention;

FIG. 26 is an explanatory diagram showing an example of backup catalogue management information in accordance with the third embodiment of this invention; and

FIG. 27 is a flowchart showing a data erasure processing procedure of a storage area according to the third embodiment of this invention.

### DETAILED DESCRIPTION OF THE PREFERRED EMBODIMENTS

Referring to the drawings, the preferred embodiments of this invention will be described.

### First Embodiment

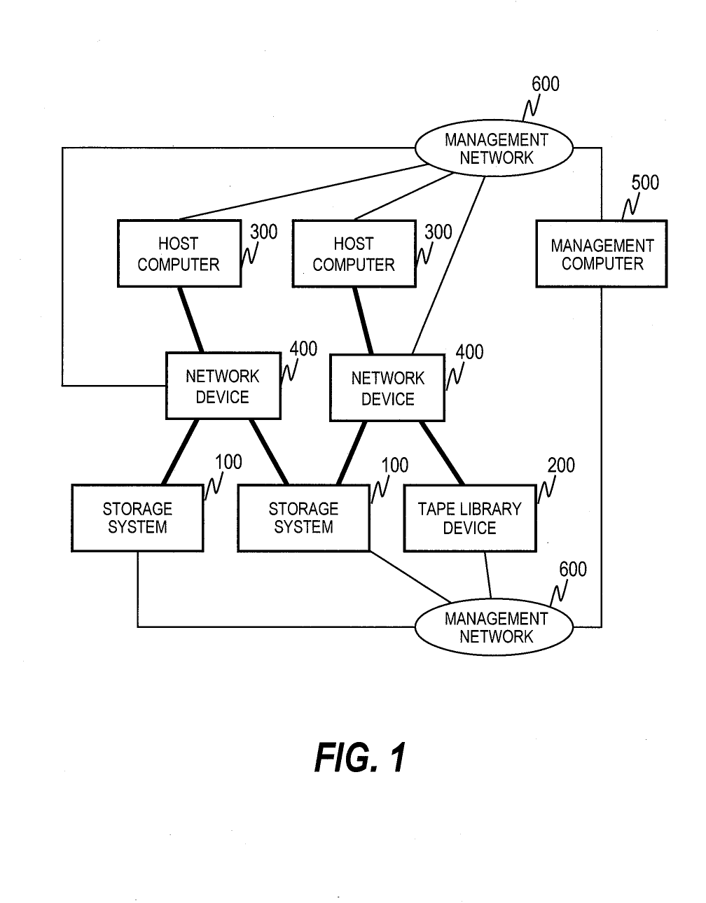

FIG. 1 illustrates a configuration of a storage area network according to a first embodiment of this invention. The storage area network includes a data I/O network and a management network 600.

The data I/O network includes a storage subsystem 100, a tape library device 200, a host computer 300, and a network device 400. The host computer 300 and the storage subsystem 100 are interconnected via the network device 400 to transfer data with each other. The data I/O network is indicated by a thick line in FIG. 1. The data I/O network is based on a conventional technology such as a fibre channel or Ethernet (registered trademark).

The management network 600 is based on a conventional technology such as a fibre channel or Ethernet. The storage subsystem 100, the tape library device 200, the host computer 300, and the network device 400 are connected to the management computer 500 via the management network 600.

In the host computer 300, an application such as a database or a file server operates to execute data input/output to a storage area. The storage subsystem 100 includes a storage device such as a magnetic disk drive mounted to provide storage areas of data read/written by the host computer 300. The tape library device 200 records a backup of data stored in the storage subsystem 100 in a tape. The network device 400 is a device such as a fibre channel for interconnecting the host computer 300 and the storage subsystem 100.

According to the first embodiment of this invention, the management network 600 and the data I/O network are independent. However, a single network that serves as both functions may be employed.

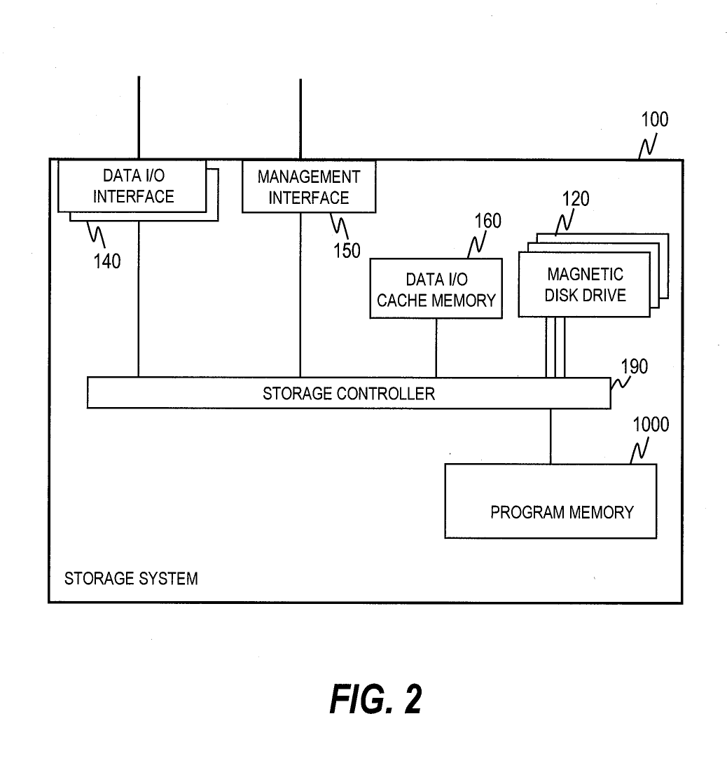

FIG. 2 illustrates a configuration of the storage subsystem 100 according to the first embodiment of this invention.

The storage subsystem 100 includes a data I/O interface 140, a management interface 150, a storage controller 190, a program memory 1000, a data I/O cache memory 160, and a magnetic disk drive 120. The data I/O interface 140, the management interface 150, the program memory 1000, the data I/O cache memory 160, and the magnetic disk drive 120 are interconnected via the storage controller 190.

The data I/O interface 140 is connected to the network device 400 via the data I/O network. The management interface 150 is connected to the management computer 500 via the management network 600. The numbers of data I/O interfaces 140 and management interfaces 150 are optional. The data I/O interface 140 doesn't have to have a configuration which is independent of the management interface 150. Management information may be input/output from the data I/O interface 140 to be shared with the management interface 150.

The storage controller 190 includes a processor mounted to control the storage subsystem 100. The data I/O cache memory 160 is a temporary storage area for achieving a high speed of input/output from the host computer 300 to the storage area. The data I/O cache memory 160 generally includes a volatile memory. However, a nonvolatile memory or a magnetic disk drive may be used instead. There is no limit on the number of data I/O cache memories 160 or a capacity. The magnetic disk drive 120 stores data read/written by the host computer 300.

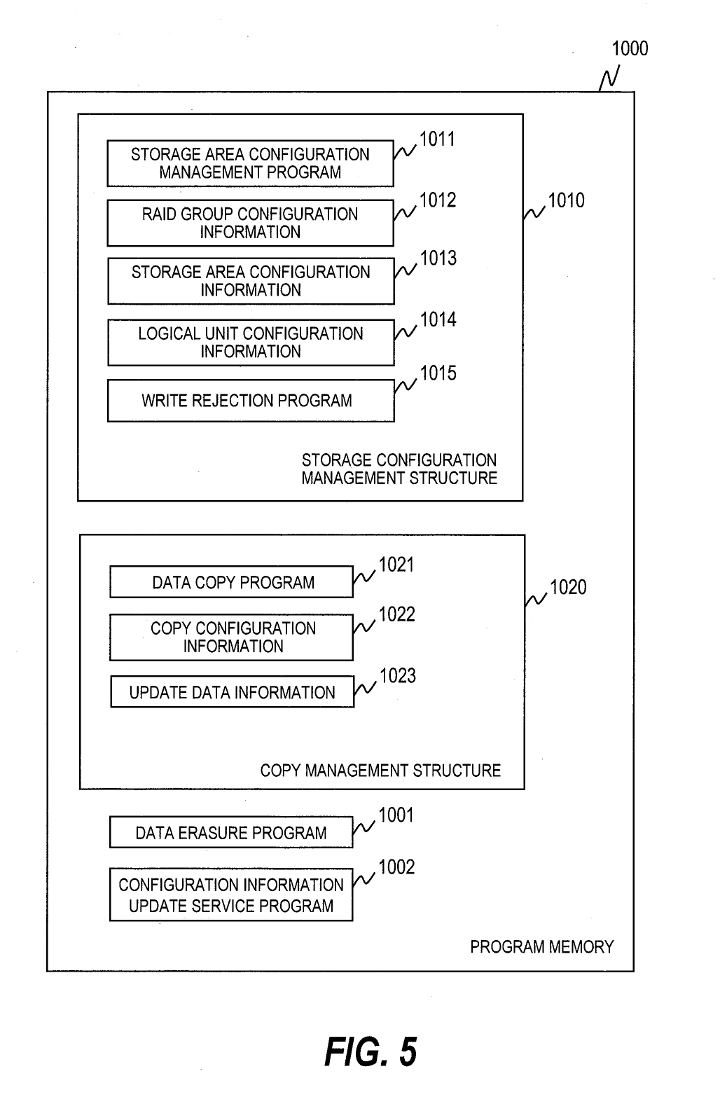

The program memory 1000 stores a program and control information necessary for a process executed by the storage subsystem 100. The program memory 1000 includes a magnetic disk drive or a volatile semiconductor memory. The control program and the control information stored in the program memory 1000 will be described below referring to FIG. 5.

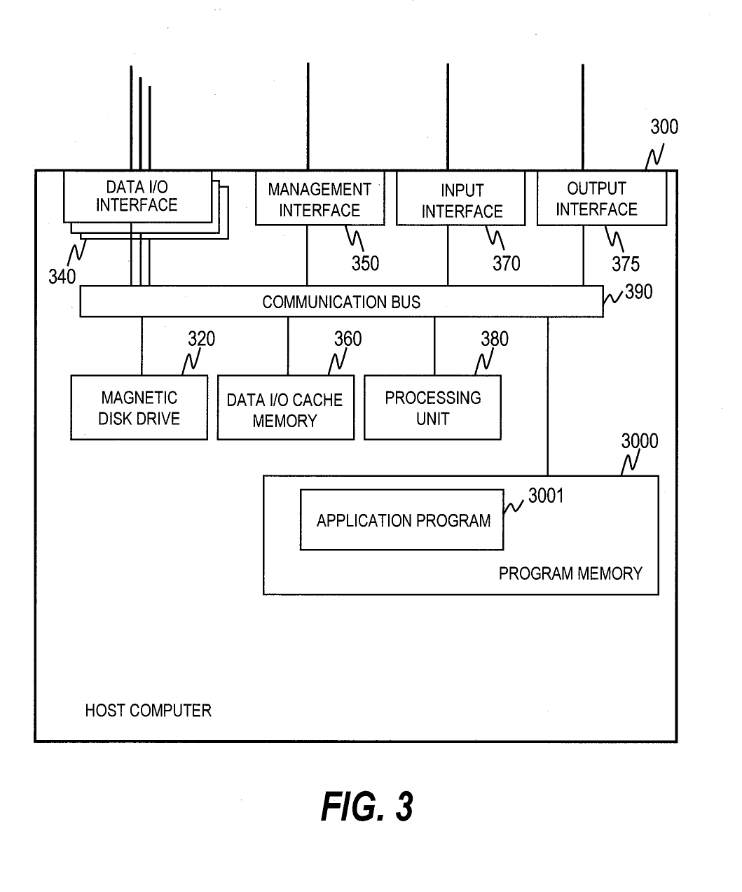

FIG. 3 illustrates a configuration of the host computer 300 according to the first embodiment of this invention.

The host computer 300 includes a data I/O interface 340, a management interface 350, an input interface 370, an output interface 375, a processing unit 380, a magnetic disk drive 320, and a data I/O cache memory 360.

The data I/O interface 340, the management interface 350, the input interface 370, the output interface 375, the processing unit 380, the magnetic disk drive 320, and the data I/O cache memory 360 are interconnected via a communication bus 390. The host computer 300 has a hardware configuration realized by a general-purpose computer (PC).

The data I/O interface 340 is connected to the network device 400 via the data I/O network to input/output data. The management interface 150 is connected to the management computer 500 via the management network 600 to input/output management information. The numbers of data I/O interfaces 340 and management interfaces 350 are optional. The data I/O interface 340 doesn't have to have a configuration which is independent of the management interface 350. Management information may be input/output from the data I/O interface 340 to be shared with the management interface 350.

The input interface 370 is connected to a device such as a keyboard or a mouse through which a user enters information. The output interface 375 is connected to a device such as a general-purpose display through which information is output to the user. The processing unit 380 executes various processes, and is equivalent to a CPU or a processor. The magnetic disk drive 320 stores an operating system and software such as an application.

The data I/O cache memory 360 includes a volatile memory, and is used for achieving a high speed of input/output in the magnetic disk drive 320. The data I/O cache memory 360 generally includes a volatile memory. However, a nonvolatile memory or a magnetic disk drive may be used instead. There is no limit on the number of data I/O cache memories 360 or a capacity.

The program memory 3000 stores a program and control information necessary for a process executed by the host computer 300. The program memory 3000 includes a magnetic disk drive or a volatile semiconductor memory.

The program memory 3000 stores an application program 3001. The application program 3001 is a program such as a database or an accounting program for creating or updating information stored in the storage subsystem 100.

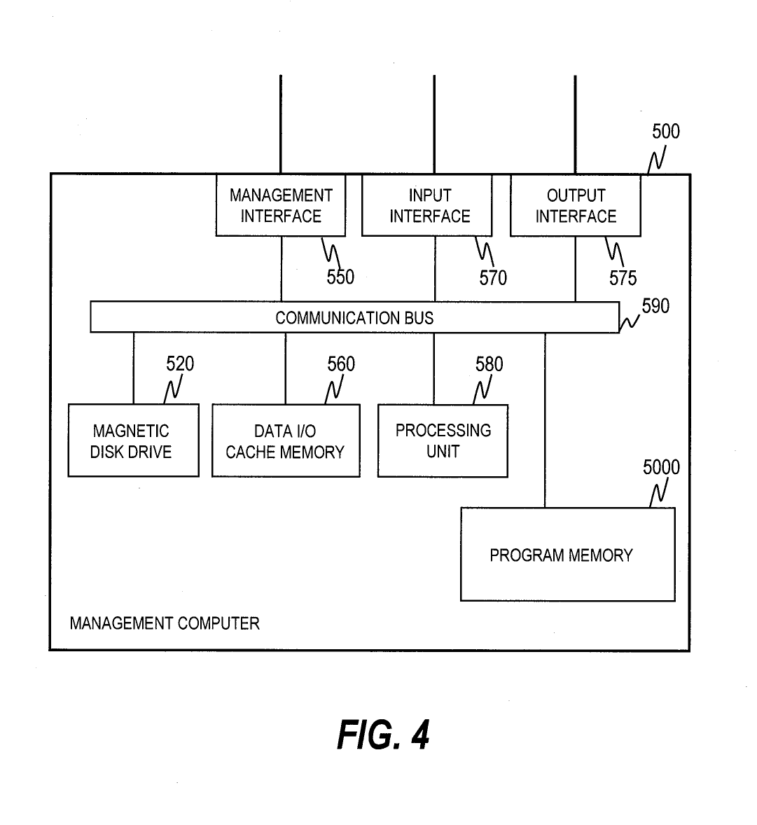

FIG. 4 illustrates a configuration of the management computer 500 according to the first embodiment of this invention.

The management computer 500 includes a data I/O interface 540, a management interface 550, an input interface 570, an output interface 575, a processing unit 580, a magnetic disk drive 520, a program memory 5000, and a data I/O cache memory 560.

The data I/O interface 540, the management interface 550, the input interface 570, the output interface 575, the processing unit 580, the magnetic disk drive 520, the program memory 5000, and the data I/O cache memory 560 are interconnected via a communication bus 590. The management computer 500 has a hardware configuration realized by a general-purpose computer (PC). Functions of the units are similar to those of the host computer 300 shown in FIG. 3.

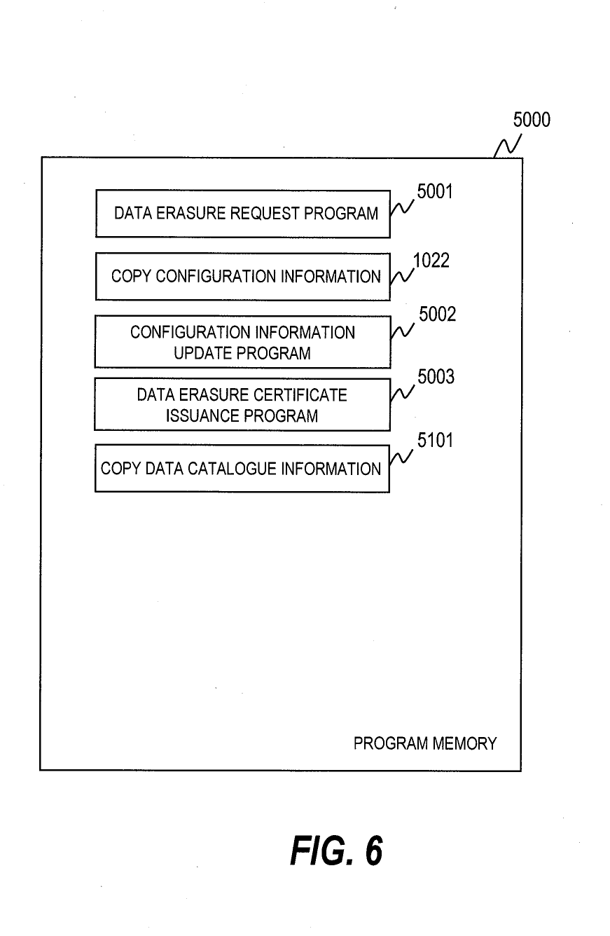

The program memory 5000 stores a program and information necessary for a process executed by the management computer 500. The program memory 5000 includes a magnetic disk drive or a volatile semiconductor memory. The program and the information stored in the program memory 5000 will be described below referring to FIG. 6.

FIG. 5 shows examples of a control program and control information stored in the program memory 1000 of the storage subsystem 100 according to the first embodiment of this invention.

The program memory 1000 includes a storage configuration management structure 1010, a copy management structure 1020, a data erasure program 1001, and a configuration information update service program 1002.

The storage configuration structure 1010 includes a program and information for managing storage resources provided by the storage subsystem 100 to the host computer 300. Specifically, the storage configuration management structure 1010 includes a storage area configuration management program 1011, RAID group configuration information 1012, storage area configuration information 1013, logical unit configuration information 1014, and a write rejection program 1015.

The storage area configuration management program 1011 is executed by the processor mounted in the storage controller 190 to manage and control storage areas provided to the host computer 300 based on the storage area configuration information 1013 described below.

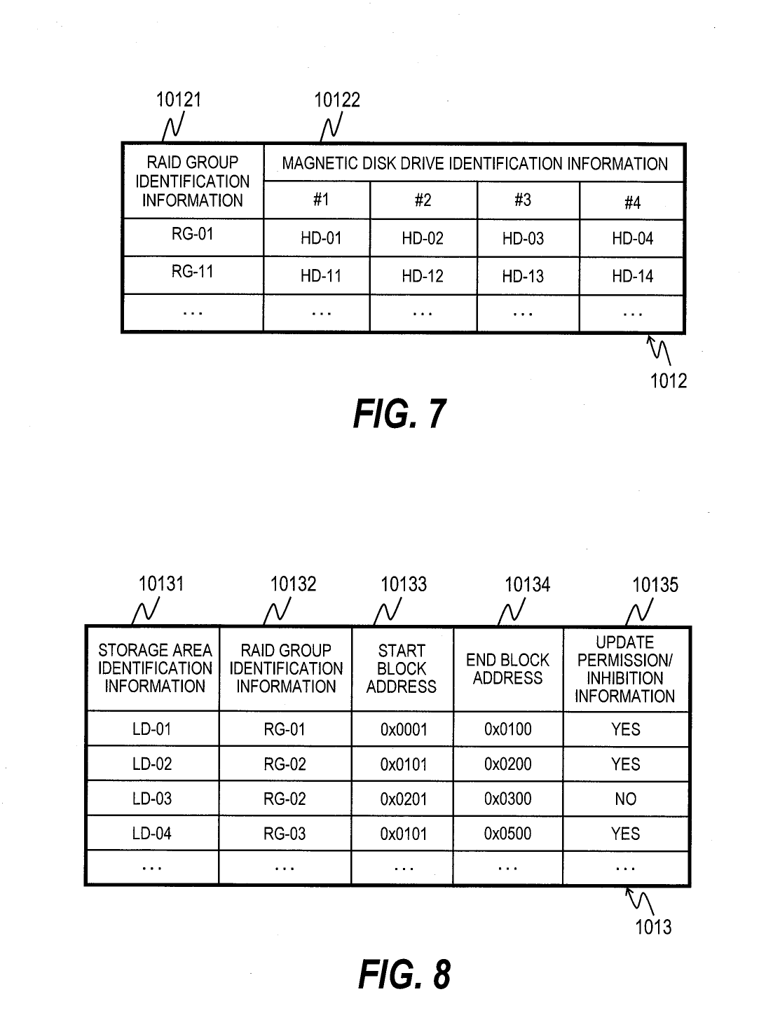

The RAID group configuration information 1012 is configuration information of a RAID group which includes a set of magnetic disk drives 120. The RAID group configuration information 1012 will be described below in detail referring to FIG. 7.

The storage area configuration information 1013 is configuration information of storage areas which are units of storage resources where the RAID group is divided into logical units. The storage area configuration information 1013 will be described below in detail referring to FIG. 8.

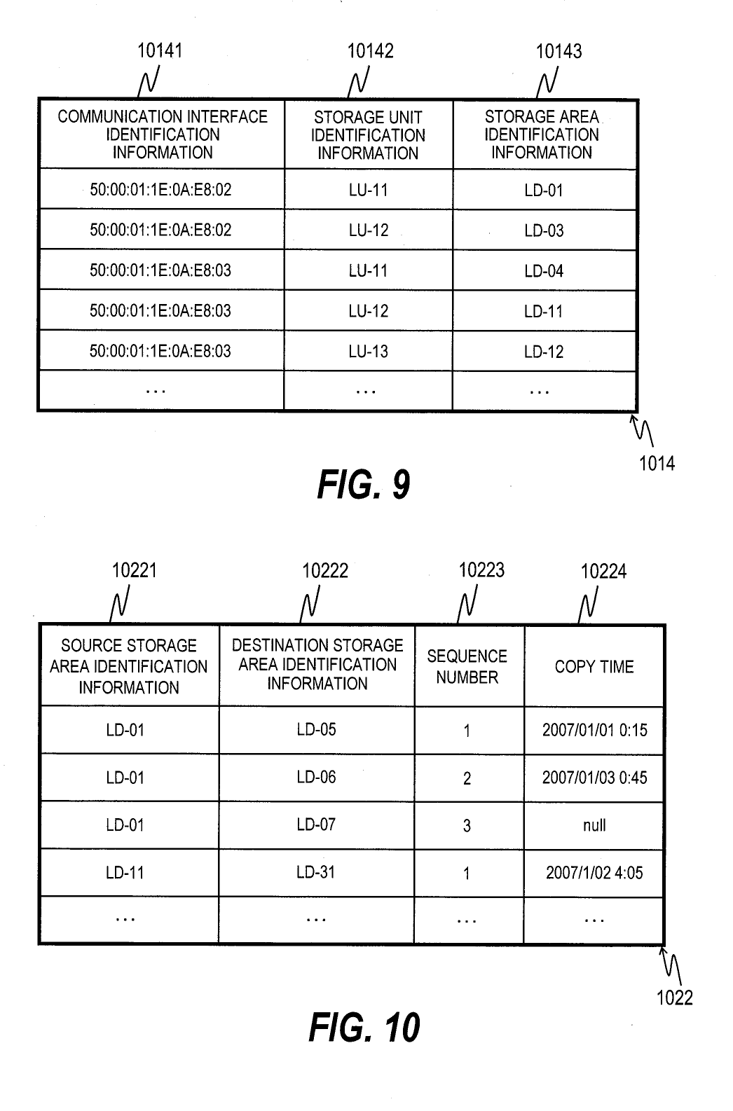

The logical unit configuration information 1014 is configuration information of logical units which are units of storage resources provided to the host computer 300. The logical unit configuration information 1014 will be described below in detail referring to FIG. 9.

The write rejection program 1015 is executed by the storage controller 190 to send an error message in response to a request without executing writing unless writing in a certain storage area is permitted when writing in the storage area is requested.

The copy management structure 1020 is a program and information for copying data stored in a storage area provided by the storage subsystem 100 to another storage area. The copy management structure 1020 includes a data copy program 1021, copy configuration information 1022, and update data information 1023.

The data copy program 1021 is executed by the storage controller 190 to copy data recorded in a source storage area to a destination storage area based on the copy configuration information 1022.

The copy configuration information 1022 contains correspondence relation between a storage area of a copy target and a storage area which becomes a copy destination of the storage area. The copy configuration information 1022 will be described below in detail referring to FIG. 10.

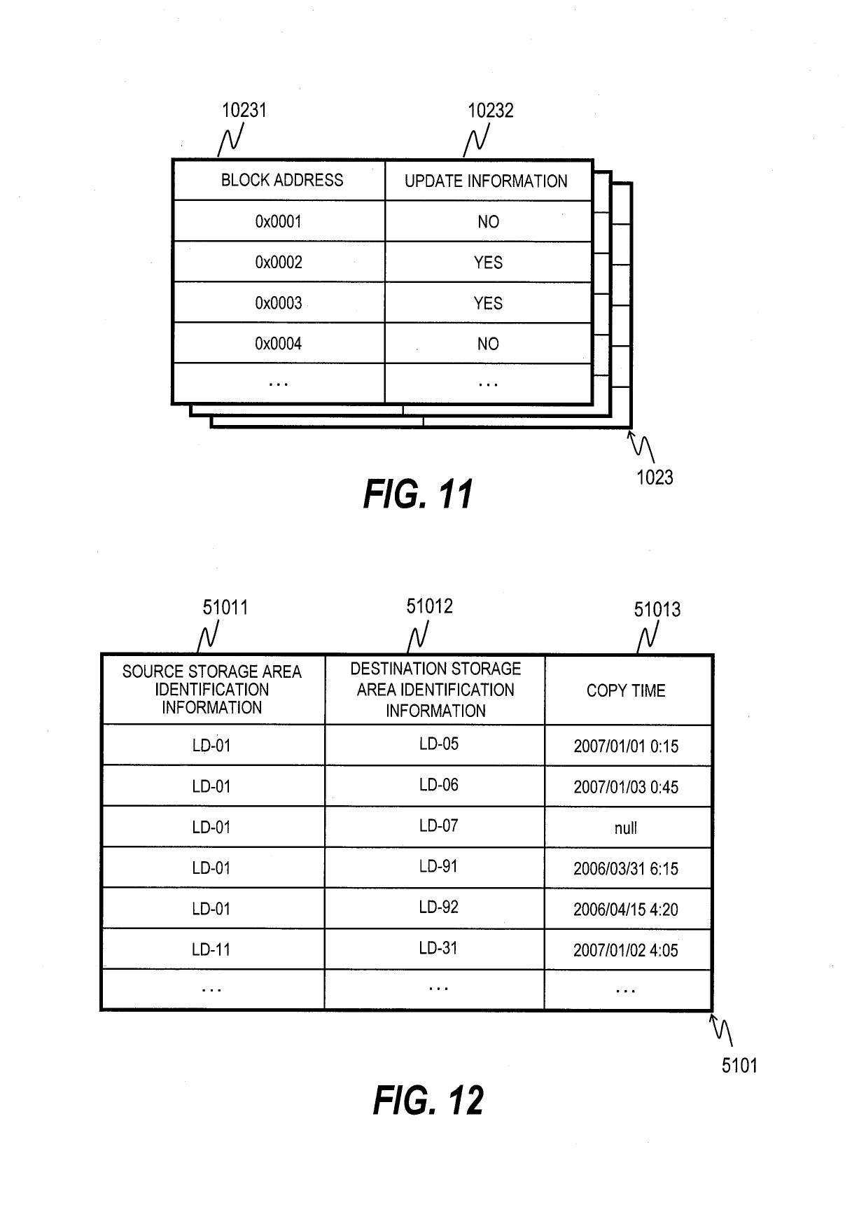

In the update data information 1023, position information of difference data not copied in the destination storage area is stored for each source storage area when data writing by the host computer 300 updates the source storage area. The update data information 1023 will be described below in detail referring to FIG. 11.

The data copy program 1021 can complete a copy process not by copying all data stored in the source storage area to the destination storage area but by copying only a difference recorded in the update data information 1023 to the destination storage area in a data copy process.

The data erasure program 1001 is executed by the storage controller 190 to overwrite the storage area with dummy data such as zero data or a random number data a plurality of times. Through overwriting of the storage area with the dummy data with dummy data a plurality of times, residual magnetism is erased from the magnetic disk drive 120 to completely inhibit data reading. The number of overwriting times is, for example, three.

The configuration information update service program 1002 is executed by the processor mounted in the storage controller 190 to transmit configuration information based on a request from the management computer 500.

FIG. 6 shows examples of a control program and control information stored in the program memory 5000 of the management computer 500 according to the first embodiment of this invention.

The program memory 5000 of the management computer 500 stores a data erasure request program 5001, copy configuration information 1022, a configuration information update program 5002, a data erasure certificate issuance program 5003, and copy data catalogue information 5101.

The data erasure request program 5001 is executed by the processing unit 580 to request data erasure to the storage subsystem 100 based on information input from an administrator. The copy configuration information 1022 contains contents similar to those of the copy configuration information 1022 stored in the storage subsystem 100.

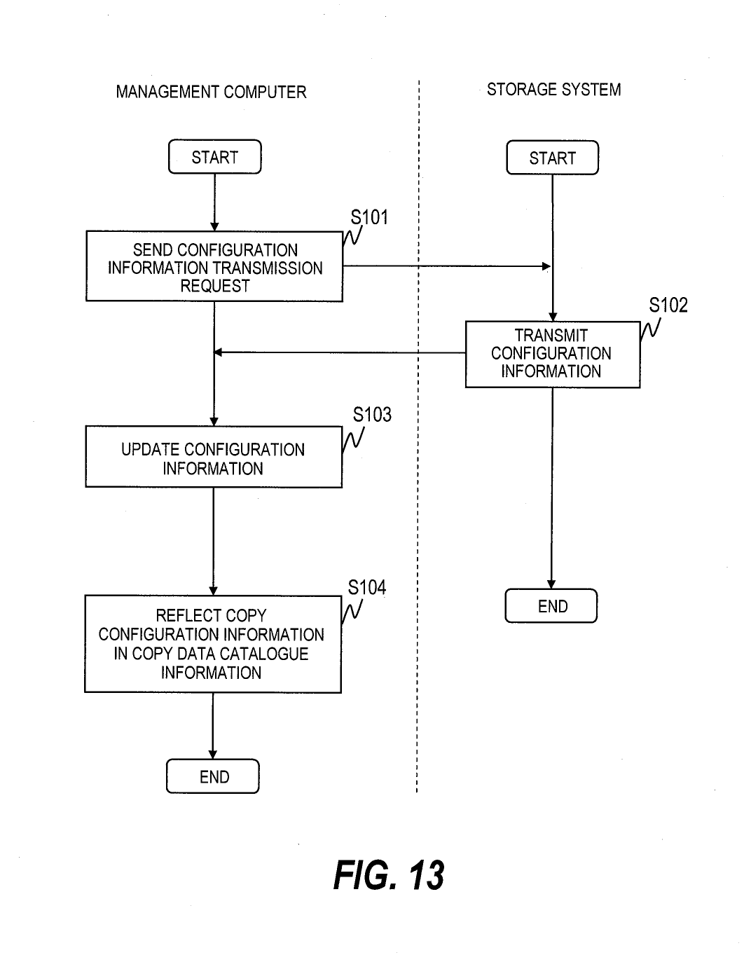

The configuration information update program 5002 is the program for obtaining and storing configuration information held by the storage subsystem 100. A processing procedure of the configuration information update program 5002 will be described below referring t o FIG. 13.

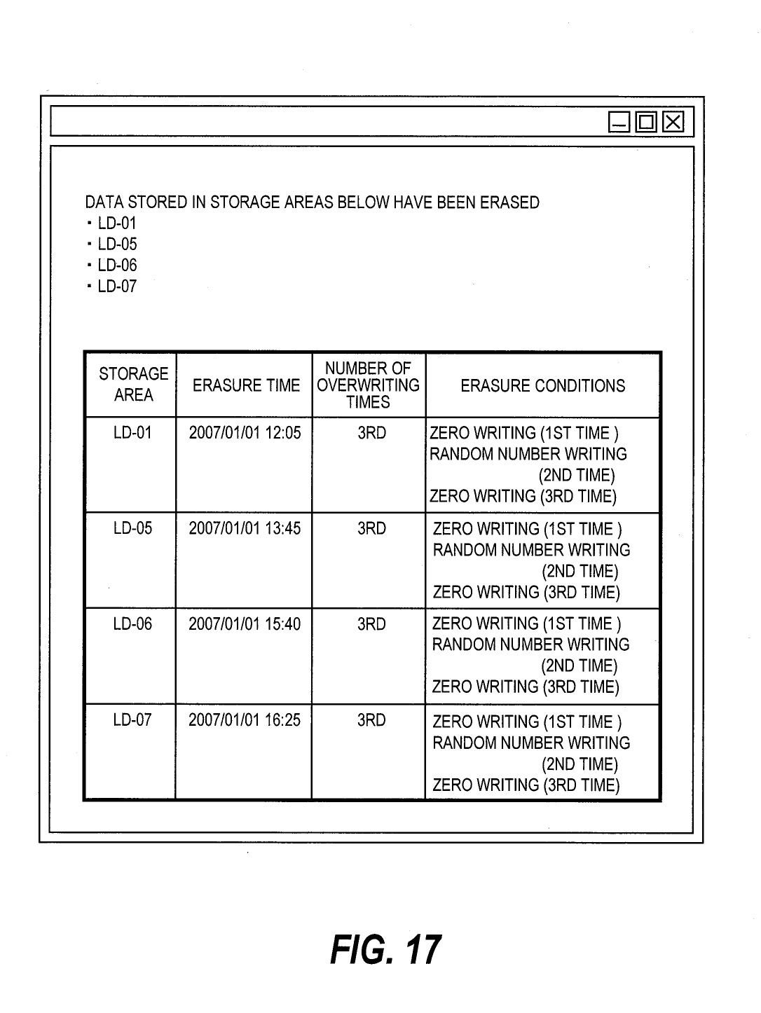

The data erasure certificate issuance program 5003 provides an erasure certificate to the administrator via the output interface 575. An example of an erasure certificate shown in FIG. 17 will be described below.

The copy data catalogue information 5101 contains storage positions of copy data created at present and in the past as a catalogue based on the copy configuration information 1022. The copy data catalogue information 5101 will be described below in detail referring to FIG. 12.

FIG. 7 shows an example of RAID group configuration information 1012 stored in the storage subsystem 100 according to the first embodiment of this invention.

The RAID group configuration information 1012 stores correspondence relation between a RAID group and magnetic disk drives constituting the RAID group. The RAID group configuration information 1012 contains RAID group identification information 10121 and magnetic disk drive identification information 10122.

The RAID group identification information 10121 is an identifier for uniquely identifying a RAID group provided in the storage subsystem 100.

The magnetic disk drive identification information 10122 is an identifier for uniquely identifying a magnetic disk drive 120 constituting the RAID group specified by the RAID group identification information 10121. For example, a RAID group “RG-01” includes magnetic disk drives “HD-01”, “HD-02”, “HD-03”, and “HD-04”.

FIG. 8 shows an example of storage area configuration information 1013 stored in the storage subsystem 100 according to the first embodiment of this invention.

The storage area configuration information 1013 contains storage area identification information 10131, RAID group identification information 10132, a start block address 10133, an end block address 10134, and update permission/inhibition information 10135.

The storage area identification information 10131 is an identifier for identifying a storage area. The RAID group identification information 10132 is an identifier for identifying a RAID group. The storage area identified by the storage area identification information 10131 is a logical storage area defined by the RAID group identified by the RAID group identification information 10132.

The start block address 10133 is a start block address of a physical area for storing a storage area identified by the storage area identification information 10131. The end block address 10134 is an end block address of a physical area for storing a storage area identified by the storage area identification information 10131.

The update permission/inhibition information 10135 is a security attribute of the storage area identified by the storage area identification information 10131. In the update permission/inhibition information 10135 of the first embodiment of this invention, “No” is recorded when writing is permitted in the storage area from an external I/O device such as the host computer 300, while “Yes” is recorded when writing is inhibited. According to the first embodiment of this invention, an attribute value is represented by a character string. However, the attribute value may be represented by a true/false value of “0” or “1”.

Upon execution of the write rejection program 1015, the storage controller 190 of the storage subsystem 100 notifies an error without executing a writing process when the update permission/inhibition information 10135 of the storage area which is a write request target is “No”. In other words, storage of data stored in the storage area is guaranteed while the update permission/inhibition information 10135 is “No”.

FIG. 9 shows an example of logical unit configuration information 1014 stored in the storage subsystem 100 according to the first embodiment of this invention. The logical unit configuration information 1014 stores correspondence among the communication interface, a storage unit which is a unit of storage resources to be accessed from the host computer 300, and a storage area.

The logical unit configuration information 1014 contains communication interface identification information 10141, storage unit identification information 10142, and storage area identification information 10143.

The communication interface identification information 10141 is an identifier for uniquely identifying the data I/O interface 140. For example, a world wide name (WWN) is stored in the communication interface identification information 10141.

The storage unit identification information 10142 is an identifier for uniquely identifying a storage unit. The storage unit is a unit of storage resources to be accessed from the host computer 300 connected to the storage subsystem 100, and equivalent to a volume mounted in a file system in which the host computer 300 operates.

The storage area identification information 10143 is an identifier for uniquely identifying a logical storage area provided by the storage subsystem 100.

FIG. 10 shows an example of copy configuration information 1022 stored in the storage subsystem 100 according to the first embodiment of this invention.

The copy configuration information 1022 contains source storage area identification information 10221, destination storage area identification information 10222, a sequence number 10223, and copy time 10224.

The processor of the storage controller 190 executes the data copy program 1021 to copy data from a storage area identified by the source storage area identification information 10221 in a storage area identified by the destination storage area identification information 10222.

The sequence number 10223 is a value indicating a copy sequence when a plurality of destination storage areas are defined for one source storage area. Execution of sequential copying in the plurality of destination storage areas by the data copy program 1021 enables creation of a plurality of generations of backups. The copy time 10224 stores time of executing data copying, in other words, backup acquisition time.

The copy configuration information 1022 stored in the management computer 300 has to enable identification of the storage subsystems 100 which provide the storage areas based on the pieces of source and destination storage area identification information when the management computer 300 manages a plurality of storage subsystems 100. Identification information of the storage subsystems 100 which provide the source and destination storage areas has to be additionally stored when the storage subsystems cannot be identified by the storage area identification information.

When the destination storage area is provided from the other storage subsystem 100, identification information of the storage subsystem 100 which provides the destination storage area has to be stored in the copy configuration information 1022 stored in the storage subsystem 100.

FIG. 11 shows an example of update data information 1023 stored in the storage subsystem 100 according to the first embodiment of this invention.

Pieces of update data information 1023 equal in number to pairs of source and destination storage areas are held in the storage subsystem 100. The update data information 1023 contains a block address 10231 and update information 10232.

Position information in the source storage area is stored in the block address 10231. In the update information 10232, “Yes” is recorded when data recorded in the block address 10231 of the source storage area has not been copied in the destination storage area, and “No” is recorded when the data has been copied. According to the first embodiment of this invention, a value stored in the update information 10232 is represented by a character string. However, the value may be represented by a true/false value of “0” or “1”.

FIG. 12 shows an example of copy data catalogue information 5101 stored in the management computer 500 according to the first embodiment of this invention.

The copy data catalogue information 5010 contains source storage area identification information 51011, destination storage area identification information 51012, and copy time 51013.

An identifier for identifying a source storage area is stored in the source storage area identification information 51011. An identifier for identifying a destination storage area is stored in the destination storage area identification information 51012. Time of execution of copying is stored in the copy time 51013.

When the management computer 300 manages a plurality of storage devices, as in the case of the configuration information 1022, identification information of the storage subsystem 100 which provides source and destination storage areas has to be stored in the copy data catalogue information 5101.

FIG. 13 is a flowchart showing a procedure of updating configuration information of the storage subsystem stored in the management computer 500 according to the first embodiment of this invention.

This process is performed by executing the configuration information update program 5002 through the processing unit 580. An outline of this process is that configuration information is obtained from the storage subsystem 100 to update the copy configuration information 1022 and the copy data catalogue information 5101.

The processing unit 580 of the management computer 500 first transmits a configuration information transmission request message to the storage subsystem 100 (step S101). In this case, requested configuration information may be designated in the configuration information transmission request message to obtain only necessary configuration information from the storage subsystem 100.

The storage controller 190 of the storage subsystem 100 executes the configuration information update service program 1002 to receive the configuration information transmission request message, and transmits the configuration information of the storage subsystem 100 to the management computer 500 based on the requested contents (step S102).

Upon reception of the configuration information transmitted from the storage subsystem 100, the processing unit 580 of the management computer 500 updates the copy configuration information 1022 stored in the program memory 5000 (step S103) based on the received configuration information.

The processing unit 580 of the management computer 500 reflects the updated information in the copy data catalogue information 5101 (step S104). In this case, past copy achievements can be stored by adding the updated information without discarding any registered information.

When a storage area where past copy data has been stored is reused because the data is used for another purpose, the data can be judged to be irrelevant to past copy data, in other words, improper to be backed up. Thus, when the storage area where the past copy data has been stored is reused, an entry where the storage area has been recorded in the destination storage area identification information 51012 may be erased from the copy data catalogue information 5101. Whether a storage area is an erasure target may be judged by adding an item for judging whether the storage area corresponding to each entry is proper to be backed up to the copy data catalogue information 5101.

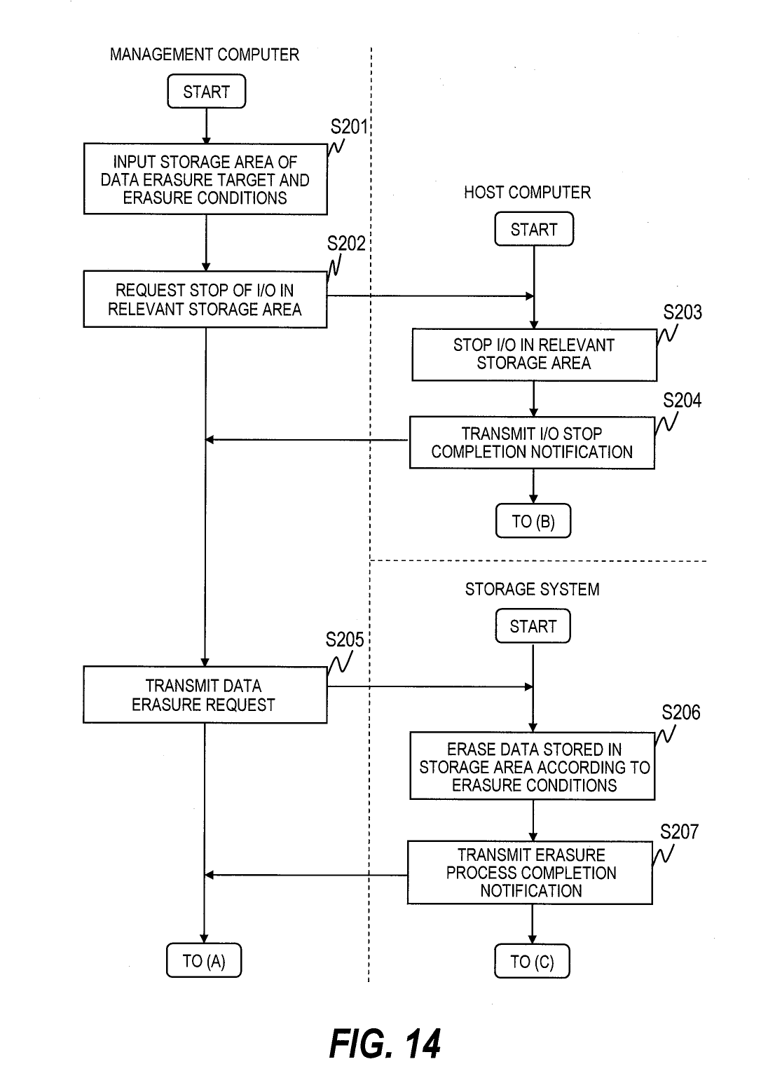

Referring to FIGS. 14 to 16, a data erasure processing procedure of the storage area according to the first embodiment of this invention will be described. The data erasure process is executed by processing the data erasure request program 5001 through the processing unit 580 of the management computer 500.

FIG. 14 is a flowchart showing a data erasure processing procedure of a storage area according to the first embodiment of this invention. The flowchart of FIG. 14 shows a procedure of erasing data stored in a designated storage area.

The processing unit 580 of the management computer 500 first executes the data erasure request program 5001 to receive an entry of a data erasure request command from the system administrator (step S201). The data erasure request command contains a data erasure target and data erasure conditions. For example, a storage area or a logical unit is designated as a data erasure target. The data erasure conditions include information regarding whether to erase copy data or backup data of data to be erased in addition to the number of overwriting times and a type of overwriting data such as zero data or random data.

Then, the processing unit 580 of the management computer 500 requests an input/output stop in the storage area of the erasure target to the host computer 300 (step S202).

In processing of the application program 3001, the processing unit 380 of the host computer 300 receives the input/output stop request in the storage area of the erasure target to stop reading/writing of data in the storage area of the erasure target (step S203). Additionally, the processing unit 580 transmits an input/output stop completion notification to the management computer 500 (step S204).

Through the process of the steps S202 to S204, the processing unit 580 of the management computer 500 stops the data input/output in the storage area of the erasure target before execution of a data erasure process to remove a possibility of failures caused by an input/output request during the erasure. The first embodiment of this invention has been described by way of procedure where the input/output stop is requested to the host computer 300. However, a writing request from the host computer 300 may be rejected by setting “No” in the update permission/inhibition information 10135 contained in the storage area configuration information 1013 of the storage subsystem 100. In this case, not an error but zero data imitating data read from the erased storage area in a pseudo manner may be returned with respect to a reading request.

The processing unit 580 of the management computer 500 transmits a data erasure request message for the storage area of the erasure target to the storage subsystem 100 (step S205).

The storage controller 190 of the storage subsystem 100 receives the data erasure request message from the management computer 500. The storage controller 190 of the storage subsystem 100 executes the data erasure program 1001 to erase data stored in a designated storage area based on erasure conditions included in the data erasure request message, and to remove residual magnetism (step S206). Specifically, an area from the start block address 10133 to the end block address 10134 is overwritten with zero data or random access data a designated number of times to erase the entire storage area and to remove residual magnetism. Upon completion of the process, the storage controller 190 of the storage subsystem 100 transmits an erasure process completion notification to the management computer 500 (step S207).

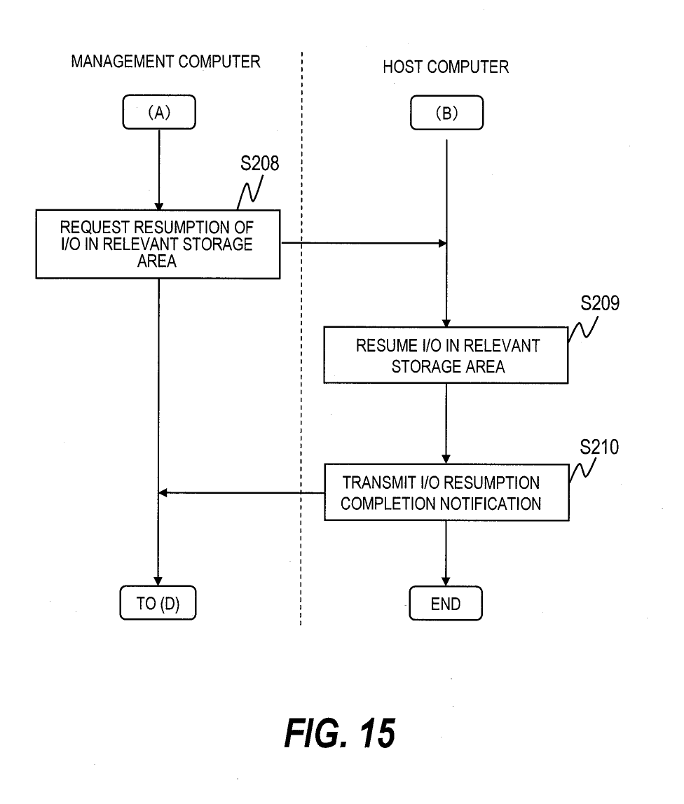

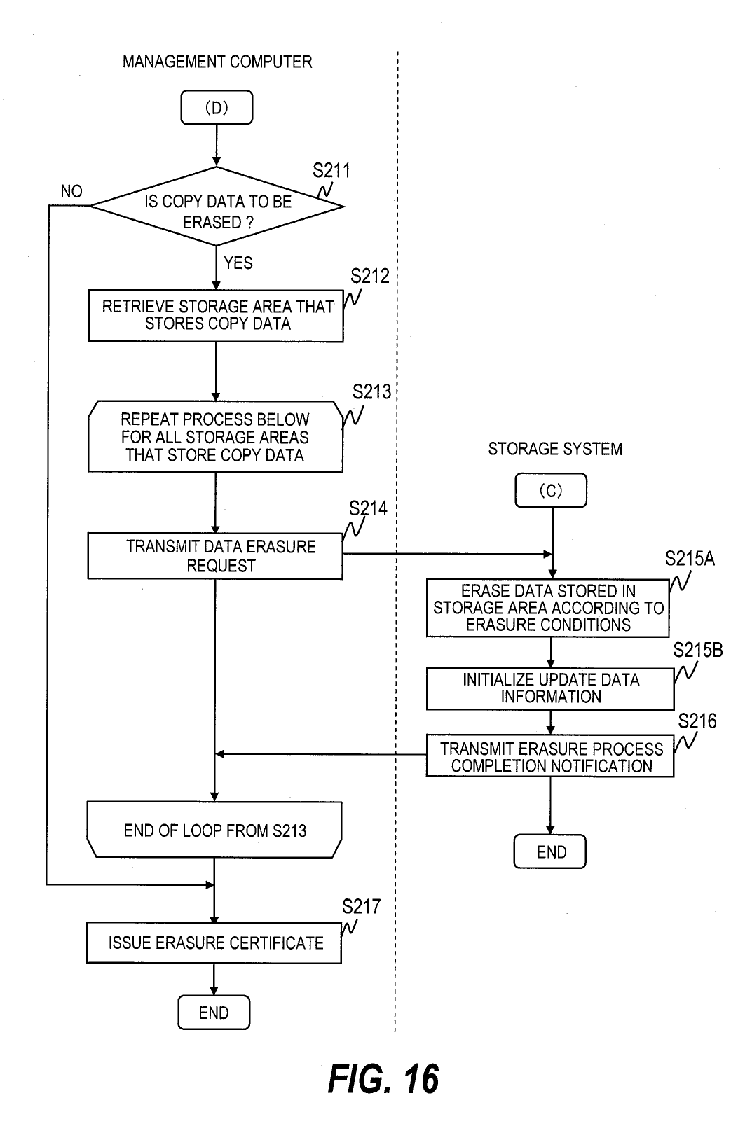

FIG. 15 is a flowchart showing a data erasure processing procedure of a storage area according to the first embodiment of this invention. The flowchart of FIG. 15 shows a procedure of resuming writing from the host computer 300.

Upon completion of the step S205 of FIG. 14 and reception of the erasure process completion notification from the storage subsystem 100, the processing unit 580 of the management computer 500 requests data input/output resumption in the storage area of the erasure target to the host computer 300 (step S208).

The processing unit 380 of the host computer 300 resumes the data input/output in the storage area of the erasure target (step S209). The processing unit 380 transmits an input/output resumption completion notification to the management computer 500 (step S210).

The execution of the process of the steps S208 to S210 enables access to the storage area of the erasure target from the host computer 300 again.

FIG. 16 is a flowchart showing a data erasure processing procedure of a storage area according to the first embodiment of this invention. The flowchart of FIG. 16 shows a procedure of erasing backup data of a storage area in which a copy of the erasure target area is stored.

The processing unit 580 of the management computer 500 judges whether the data erasure conditions entered in the step S201 include an instruction of erasing copy data (step S211).

In the case of erasing the copy data (result of the step S211 is “Yes””, the processing unit 580 of the management computer 500 refers to the copy data catalogue information 5101 to retrieve and obtain a storage area for storing a copy of the storage area of the erasure target (step S212).

The processing unit 580 of the management computer 500 repeats the data erasure process below for all destination storage areas obtained in the process of the step S212 (step S213).

The processing unit 580 of the management computer 500 transmits a data erasure request message targeting a destination storage area for erasure to the storage subsystem 100 (step S214).

Upon reception of the data erasure request message, the storage controller 190 of the storage subsystem 100 erases data of the storage area of the erasure target to remove residual magnetism based on erasure conditions included in the data erasure request message (step S215A).

The storage controller 190 of the storage subsystem 100 initializes update data information 1023 storing a pair relation between the source storage area and destination storage area (step S215B). The process of the step S215B is the process for preventing copying of all data overwritten in the source storage area during next difference data copying because the source storage area and the destination storage area have been erased. The initialization process of the update data information 1023 only needs to record “No” in the update information 10232 of all the storage areas of the erasure target.

The storage controller 190 of the storage subsystem 100 transmits an erasure process completion notification to the management computer 500 upon completion of the data erasure of the storage area of the erasure target (step S216).

Upon completion of data erasure of all the destination storage areas obtained in the process of the step S212, the processing unit 580 of the management computer 500 writes information of the erased storage areas together with erasure conditions and time in an erasure certificate to output the certificate from the output interface 575 (step S217). The erasure certificate may be output in a screen or printed on paper by a printer.

In the case of not erasing the copy data (result of the step S211 is “No”), the processing unit 580 of the management computer 500 issues an erasure certificate without erasing the copy data (step S217).

FIG. 17 shows an output example of an erasure certificate according to the first embodiment of this invention.

A list of data-erased storage areas is output together with erasure conditions to the erasure certificate. When an erasure target is a destination storage area, time of copying data may be specified by writing the copy time 10224 of the copy configuration information 1022. When the administrator enters the source storage area as an erasure target in the step S201, the number of erased storage areas and identification information may also be output to the erasure certificate.

A flow of the data erasure process of the first embodiment of this invention will specifically be described based on the aforementioned procedure.

A case where erasure of a storage area “LD-01” is designated as a storage area of an erasure target by the administrator in the step S201 of FIG. 14 will be described. Erasure conditions entered in the step S201 are that erasure of the destination storage area is executed, and an algorithm is instructed such that the number of overwriting times is three: all storage areas are overwritten with zero data for the first time, overwritten with random number data for the second time, and overwritten with zero data again for the third time.

The processing unit 580 of the management computer 500 instructs the host computer 300 to temporarily stop execution of the application program 3001 input/output to the “LD-01” (step S203). The processing unit 580 instructs the storage subsystem 100 to erase data of the “LD-01” (step S206).

Upon completion of the data erasure, the processing unit 580 of the management computer 500 resumes the data input/output in the “LD-01” by the execution of the application program 3001 (step S209).

Subsequently, the processing unit 580 of the management computer 500 refers to the copy configuration information 1022 to obtain a destination storage area of the “LD-01” as erasure of the copy data is included in the erasure conditions (step S212). Specifically, “LD-05”, “LD-06”, and “LD-07)” can be obtained as destination storage areas by referring to the copy configuration information 1022 of FIG. 10. In the case of obtaining a storage area used as a destination storage area in the past, the processing unit 580 only needs to refer to the copy data catalogue information 5101 shown in FIG. 12.

The processing unit 580 of the management computer 500 executes an erasure process for the destination storage areas “LD-05”, the “LD-06”, and the “LD-07” of the erasure target (step S213).

Upon reception of a request from the management computer 500, the storage controller 190 of the storage area 100 executes erasure of the “LD-05”, the “LD-06”, and the “LD-07” (step S215).

Lastly, the processing unit 580 of the management computer 500 issues an erasure certificate shown in FIG. 17 (step S217) to finish the process.

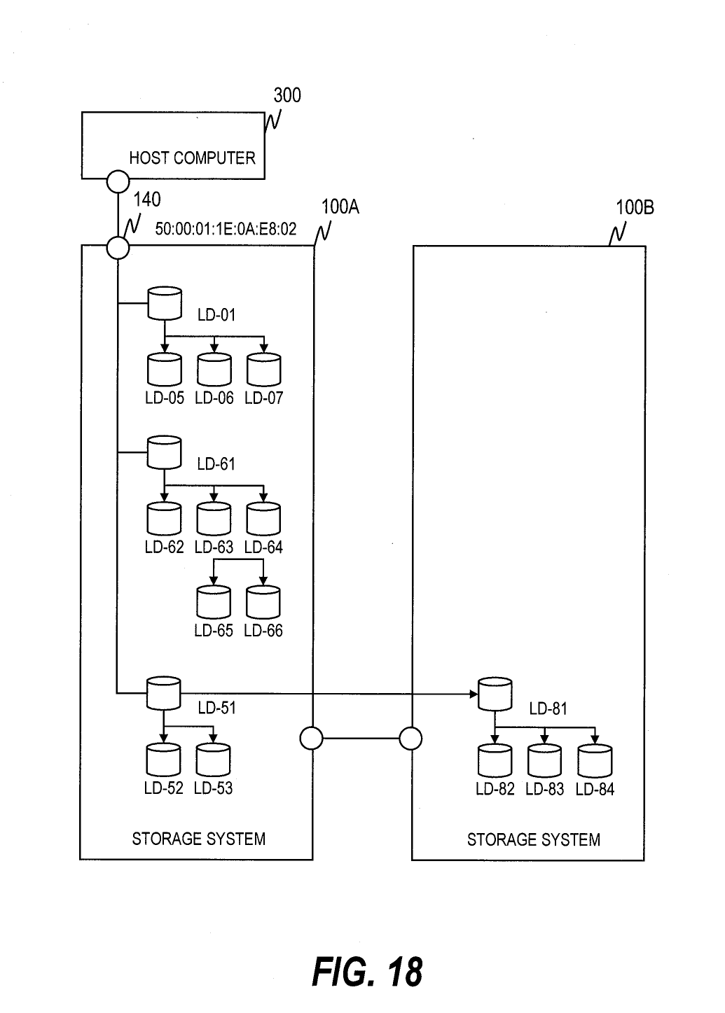

FIG. 18 shows a copy configuration of the storage subsystem 100 according to the first embodiment of this invention. FIG. 18 shows two storage subsystems 100A and 100B. The storage subsystems 100A and 100B are similar to the storage subsystem 100 in configuration.

Referring to the copy configuration information shown in FIG. 10, “LD-05”, “LD-06”, and “LD-07” are registered as destination storage areas in the storage area “LD-01”. With this configuration, the “LD-01”, the “LD-05”, the “LD-06”, and the “LD-07” are targets of erasure when erasure of the “LD-01” and the destination storage areas is instructed.

A cascade configuration may be employed for the copy configuration. Specifically, “LD-62”, “LD-63”, and “LD-64” are registered as destination storage areas in a storage area “LD-61”. “LD-65” and “LD-66” are registered as destination storage areas in the storage area “LD-63”. With the cascade configuration, data recorded in the “LD-65” and the “LD-66” are copies at the time of specifying the “LD-61”. Accordingly, when data erasure of the “LD-61” is instructed, and data erasure of the destination storage area is instructed as erasure conditions, the storage areas “LD-62”, “LD-63”, “LD-64”, “LD-65”, and “LD-66” become targets of erasure, and data are erased in the step S215.

A remote copy configuration where a copy of the storage subsystem 100 is stored may be employed for the copy configuration. In a storage area “LD-51”, “LD-52” and “LD-53” are created as destination storage areas in the storage subsystem 100A, and “LD-81” is created in the storage subsystem 100B. In other words, the “LD-51” and the “LD-81” constitute a remote copy. In the “LD-81”, storage areas “LD-82”, “LD-83”, and “LD-84” of the storage subsystem 100B are destination storage areas. With this configuration, when data erasure of the “LD-51” is instructed, and data erasure of the destination storage area is instructed as erasure conditions in the step S201, the storage areas “LD-52”, “LD-53”, “LD-81”, “LD-82”, “LD-83”, and “LD-84” become targets of erasure.

When the storage subsystem 100B for storing a copy as in the case of the remote copy configuration is different from the storage subsystem 100A for providing a volume for storing data to be erased, the copy configuration information 1022 and the copy data catalogue information 5101 have to contain identification information of the storage subsystem as described above.

In the case of the remote copy configuration, a data erasure request to the storage subsystem 100B may be transmitted from the storage subsystem 100A, or the management computer 300. When a copy of data recorded in the past is stored, and a stored storage area is erased, a data erasure request has to be transmitted to the storage subsystem which includes the storage area referring to the copy data catalogue information 5101 stored in the management computer 300.

According to the first embodiment of this invention, when data of a designated storage area is erased, a copy of the data such as backup data can simultaneously be erased.

According to the first embodiment of this invention, since complete erasure even including the residual magnetism of the backup data is executed, so data restoration can be prevented to reduce security risks.

### Second Embodiment

The first embodiment of this invention has been directed to the technology of erasing the data stored in the destination storage area of the storage area when the data stored in the designated storage area is erased. However, a second embodiment of this invention is directed to a case where data stored in another form is erased regarding data stored in storage areas of erasure targets. Specifically, the second embodiment is applied to the technology of switching the storage area constituting the logical unit of the storage subsystem 100 to another storage area which is disclosed in JP 2005-209149 A. According to the technology disclosed in JP 2005-209149 A, data stored in the storage area at the time of switching the storage area can be stored.

Description of contents of the second embodiment of this invention similar to those of the first embodiment will be omitted.

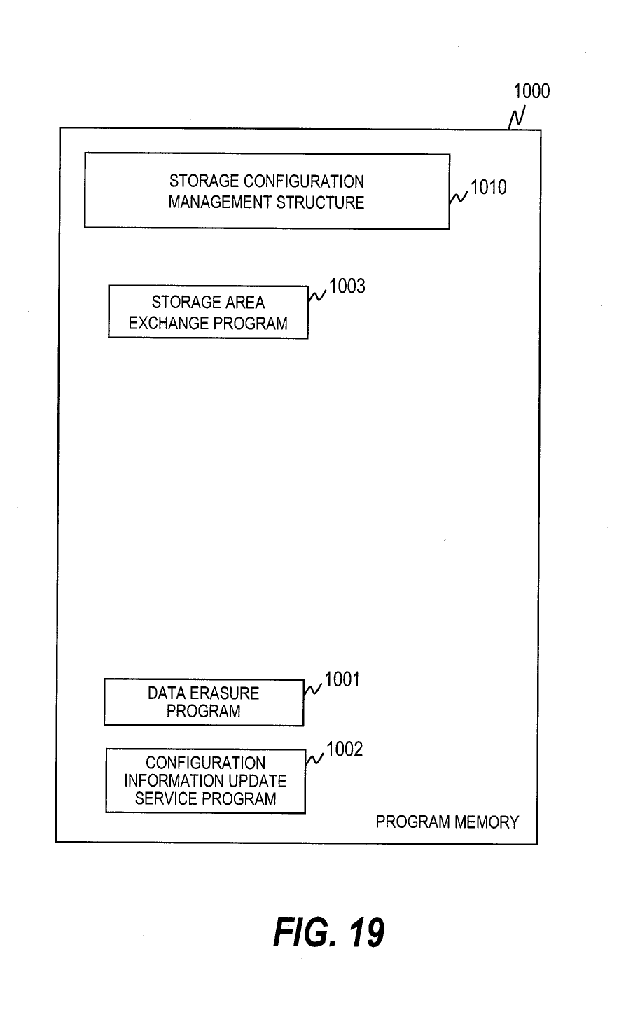

FIG. 19 shows examples of a control program and control information stored in a program memory 1000 of a storage subsystem 100 according to the second embodiment of this invention.

The control program and the control information stored in the program memory 1000 of the second embodiment of this invention include a storage area exchange program 1003 in place of the copy management structure 1020. A storage configuration management structure 1010, a data erasure program 1001, and a configuration information update service program 1002 are similar to those of the first embodiment of this invention.

The storage area exchange program 1003 substitutes a storage area constituting a logical unit with another storage area. For example, referring to the logical unit configuration information 1014 shown in FIG. 9, a logical unit whose identification information is “LU-11” is defined in the data I/O interface 140 whose identification information is “5:00:01:1E:0A:E8:02”. A storage area constituting the logical unit is “LD-01”.

In this case, a storage controller 190 of the storage subsystem 100 executes the storage area exchange program 1003 to update storage area identification information corresponding to the data I/O interface 140 to “LD-02”. After the updating of the storage area identification information corresponding to the data I/O interface 140 to the “LD-02”, a host computer 300 that accesses the storage unit “LU-11” reads/writes data not in the “LD-01” but in “LD-02” thereafter. Data at the time of releasing from the storage unit can be stored by setting update permission/inhibition information 10135 of the storage area to be substituted (e.g., “LD-01”) to “No”.

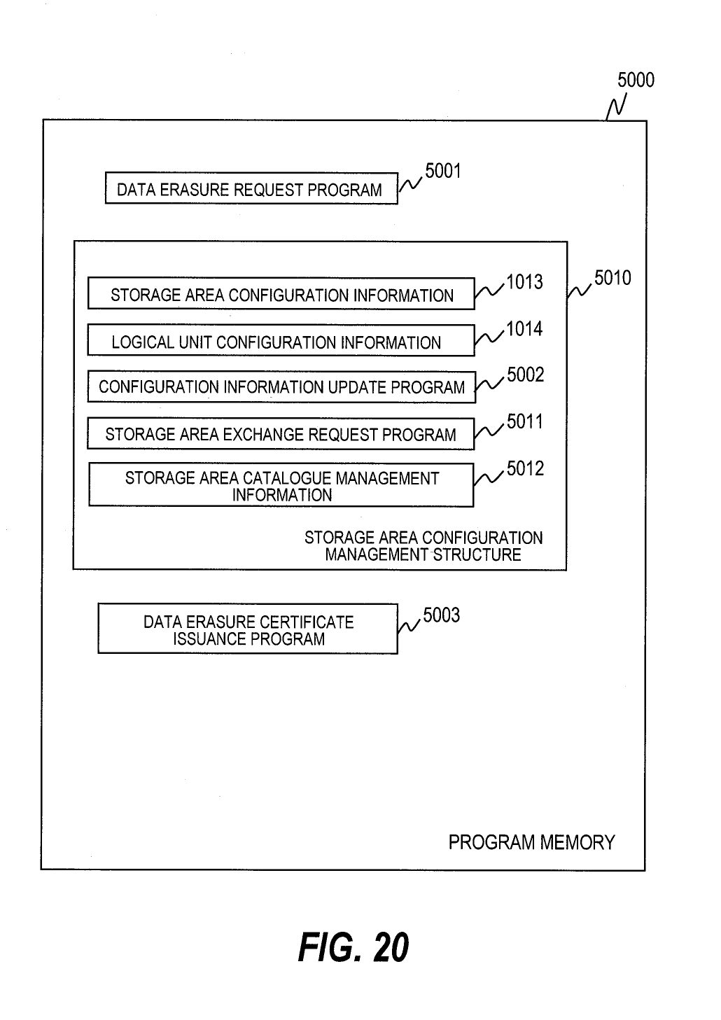

FIG. 20 shows examples of a control program and control information stored in the program memory 5000 of the management computer 500 according to the second embodiment of this invention.

The program memory 5000 of the management computer 500 stores a data erasure request program 5001, the storage area configuration management structure 5010 and the data erasure certificate issuance program 5003.

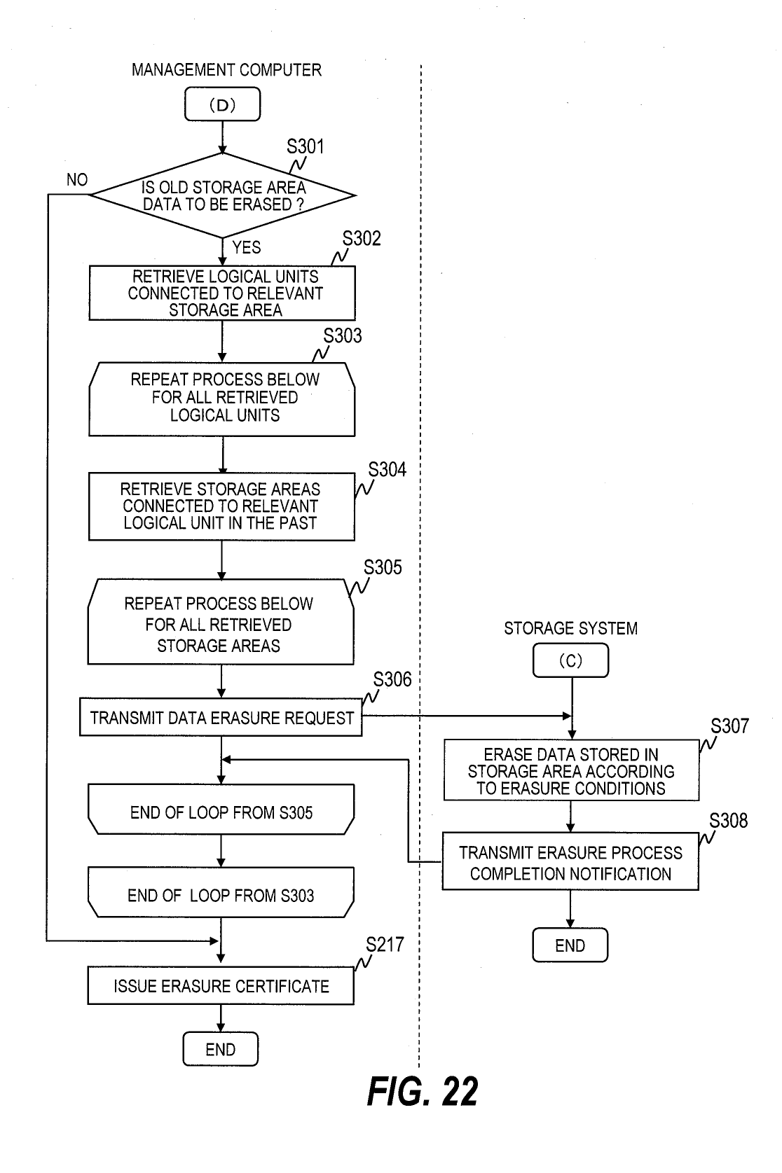

The data erasure request program 5001 is similar to that of the first embodiment of this invention in terms of requesting data erasure to the storage subsystem 100. Process differences will be described below referring to FIG. 22.

The storage area configuration management structure 5010 contains a program and information for managing and controlling data storage using a storage area exchange technology. Specifically, the storage area configuration management structure 5010 contain storage area configuration information 1013, logical unit configuration information 1014, a configuration information update program 5002, a storage area exchange request program 5011, and storage area catalogue management information 5012.

The storage area configuration information 1013 and the logical unit configuration information 1014 are obtained from the storage subsystem 100 by executing a configuration information update program 5002. A procedure of updating configuration information by the configuration information update program 5002 is similar to that of the first embodiment of this invention shown in FIG. 13.

The storage area exchange request program 5011 is the program for instructing storage area switching to the storage subsystem 100 based on a storage area exchange request operation entered by an administrator via an input interface 570.

In the storage area catalogue management information 5012, the storage area exchange program 1003 is executed by the storage subsystem 100 according to a storage area switching instruction to store history information of switched storage areas.

The data erasure certificate issuance program 5003 is the program for providing an erasure certificate to the administrator via an output interface 575 as in the case of the first embodiment of this invention.

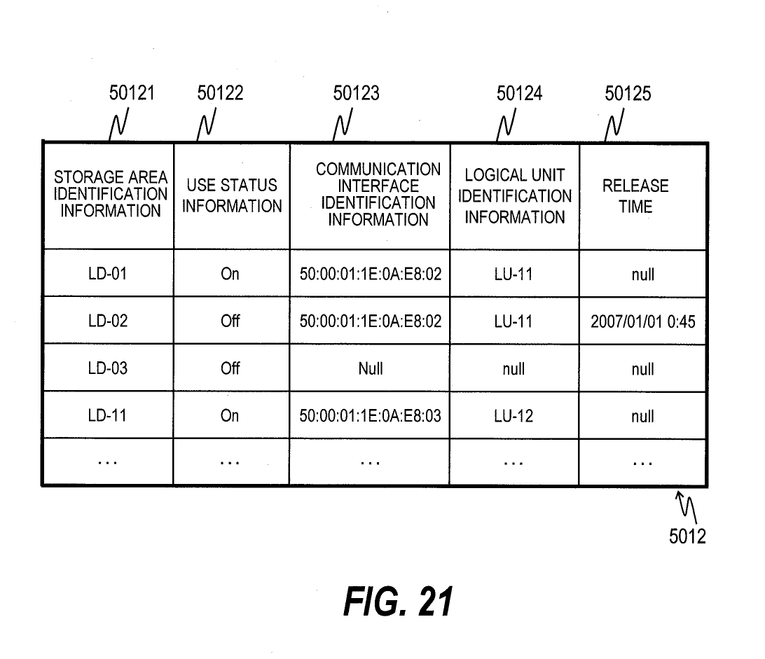

FIG. 21 shows an example of storage area catalogue management information 5012 stored in the management computer 500 according to the second embodiment of this invention.

The storage area catalogue management information 5012 contains storage area identification information 50121, use status information 50122, communication interface identification information 50123, logical unit identification information 50124, and release time 50125.

In the storage area identification information 50121, identifiers of a storage area constituting a logical unit, and a storage area having constituted a logical unit in the past, replaced by executing a storage area exchange program, and currently not constituting any logical unit are stored.

In the use status information 50122, “On” is set when a storage area identified by the storage area identification unit 50121 constitutes a logical unit, and “Off” is set unless the storage area constitutes a logical unit. According to the second embodiment of this invention, a value of the use status information 50122 is represented by a character string. However, the value may be represented by a true/false value of “0” or “1”.

In the communication interface identification information 50123 and the logical unit identification information 50124, identification information of the data I/O interface 140 and identification information of a logical unit defined in the data I/O interface 140 are stored. In other words, information indicating that the storage area identified by the storage area identification information 50121 constitutes a logical unit at present or has constituted a logical unit in the past is stored.

In the release time 50125, time of substituting a storage area having constituted a logical unit in the past, which is identified by storage area identification information, with another storage area through execution of the storage area exchange program 1003 is stored.

FIG. 22 is a flowchart showing a data erasure processing procedure of a storage area according to the second embodiment of this invention.

A procedure of erasing data stored in a designated storage area shown in FIG. 14 and a procedure of resuming data access to the storage subsystem 100 from the host computer 300 shown in FIG. 15 are similar to those of the first embodiment of this invention. The data erasure process is executed by executing a data erasure request program 5001 via a processing unit 580 of the management computer 500.

The procedure shown in the flowchart of FIG. 22 is executed after the step S210 of FIG. 15. An outline of the process is that search is carried out in the storage area catalogue management information 5012 to specify a storage area of an erasure target, thereby erasing data of the storage area of the erasure target.

The processing unit 580 of the management computer 500 judges whether entered data erasure conditions include an instruction of erasing a storage area (old storage area) having constituted a logical unit including a storage area of an erasure target in the past (step S301).

When the old storage area is an erasure target (result of the step S301 is “Yes”), the processing unit 580 of the management computer 500 refers to the storage area catalogue management information 5012 to retrieve and obtain all logical units including the erasure target storage area (step S302).

The processing unit 580 of the management computer 500 executes a process below for all the logical units obtained in the process of the step S302 (step S303).

The processing unit 580 of the management computer 500 refers to the storage area catalogue management information 5012 to retrieve and obtain all storage areas having constituted the logical units in the past (step S304). The processing unit 580 executes a process below for all the obtained storage areas (step S305).

The processing unit 580 of the management computer 500 transmits a data erasure request message targeting the old storage area to the storage subsystem 100 (step S306). Upon reception of the data erasure request message, the storage controller 190 of the storage subsystem 100 erases data of a designated storage area and removes residual magnetism based on erasure conditions (step S307). Upon completion of the data erasure process, the processing unit 580 of the management computer 500 transmits an erasure process completion notification to the management computer 500 (step S308).

A flow of the data erasure process of the second embodiment of this invention will be described more specifically based on the aforementioned procedure.

A case where an administrator instructs erasure of a storage area “LD-01” as a storage area of an erasure target in the process of the step S201 of FIG. 14 will be described. It is presumed that erasure of an old storage area substituted with the “LD-01” in the past is instructed by erasure conditions entered in the step S201.

After the erasure of the storage area “LD-01” in the step S206, the processing unit 580 of the management computer 500 refers to the storage area catalogue management information 5012 to obtain information of a logical unit including the storage area “LD-01” (step S302). Specifically, referring to the storage area catalogue management information 5012 shown in FIG. 21, an obtained logical unit is “LU-11” defined in the communication interface “50:00:01:1E:0A:E8:02”. Further, the fact that a storage area “LD-02” has constituted the logical unit “LU-11” in the past can be specified (step S304). The processing unit 580 of the management computer 500 also executes a data erasure process of the specified storage area “LD-02” (step S307).

According to the second embodiment of this invention, data offline from the host computer 300 regarding not only a storage area forming a pair with the storage area of the erasure target but also a copy of the storage area of the erasure target obtained in the past can be erased.

### Third Embodiment

The first embodiment and the second embodiment of this invention have been described of the case where the data copy is stored in the magnetic disk drive. However, a third embodiment of this invention is directed to a data erasure technology of a backup system for storing data stored in a storage area in a tape recording medium.

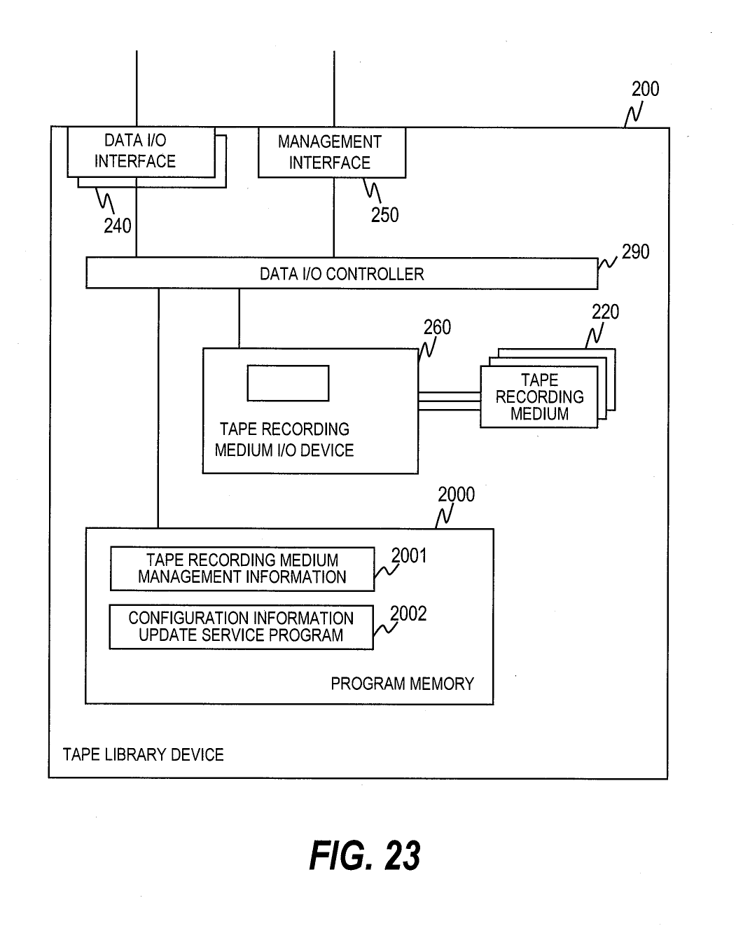

FIG. 23 illustrates a configuration of a tape library device 200 according to the third embodiment of this invention.

The tape library device 200 includes a data I/O interface 240, a management interface 250, a data I/O controller 290, a tape recording medium I/O device 260, a tape recording medium 220, and a program memory 2000. The data I/O interface 240, the management interface 250, the tape recording medium I/O device 260, and the program memory 2000 are interconnected via the data I/O controller 290.

The data I/O interface 240 is connected to a network device 400 via a data I/O network. The management interface 250 is connected to a management computer 500 via a management network 600. The numbers of data I/O interfaces 240 and management interfaces 250 are optional. The data I/O interface 240 doesn't have to have a configuration which is independent of the management interface 250. Management information may be input/output from the data I/O interface 240 to be shared with the management interface 250.

The tape recording medium I/O device 260 controls data reading/writing in a tape recording medium. The tape recording medium 200 is a magnetic tape.

The data I/O controller 290 loads a tape recording medium 220 of a reading or writing destination in the tape recording medium I/O device 260 based on an I/O command to execute a data reading or writing process in the tape recording medium 220.

The program memory 2000 stores a program and information necessary for a process executed by the tape library device 200. The program memory 2000 includes a magnetic disk drive or a volatile semiconductor memory.

The program memory 2000 stores tape recording medium management information 2001 and a configuration information update program 2002.

The tape recording medium management information 2001 is management information of the tape recording medium 220 mounted in the tape library device 200. The configuration information update program 2002 is the program for transmitting configuration information based on a request from the management computer 500.

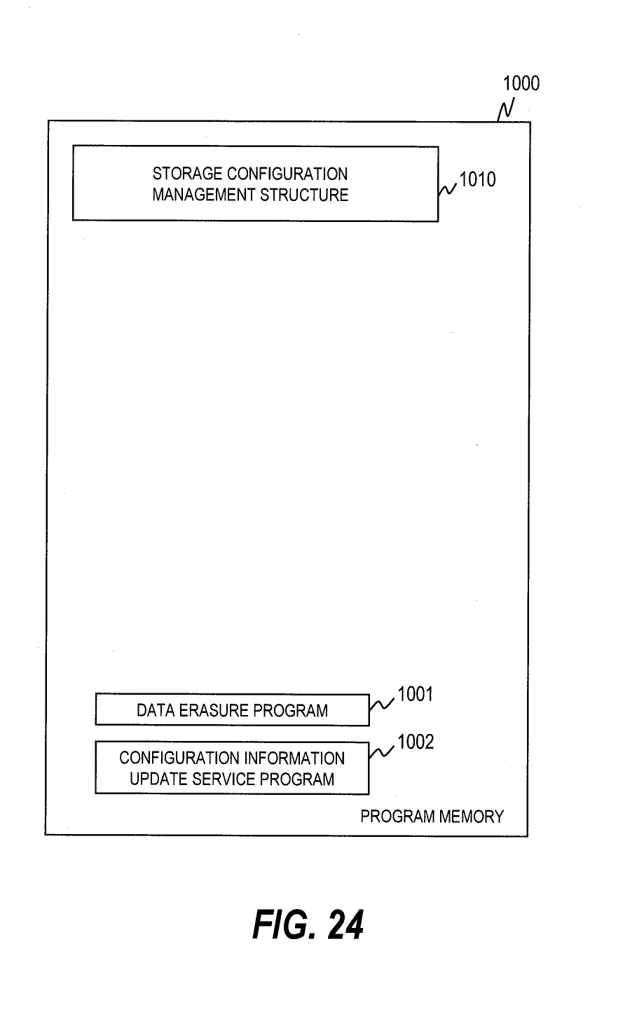

FIG. 24 shows examples of a control program and control information stored in a program memory 1000 of the storage subsystem 100 according to the third embodiment of this invention.

The program memory 1000 includes a storage configuration management structure 1010, a data erasure program 1001, and a configuration information update service program 1002.

A backup of data is created in the program memory 1000 of the storage subsystem 100 of the third embodiment of this invention by the tape library device 200. Thus, the program memory is different from those of the first embodiment and second embodiment of this invention in that no copy management structure or the like is included.

Functions of the storage configuration management structure 1010, the copy management structure 1020, the data erasure program 1001, and the configuration information update service program 1002 are similar to those of the second embodiment of this invention.

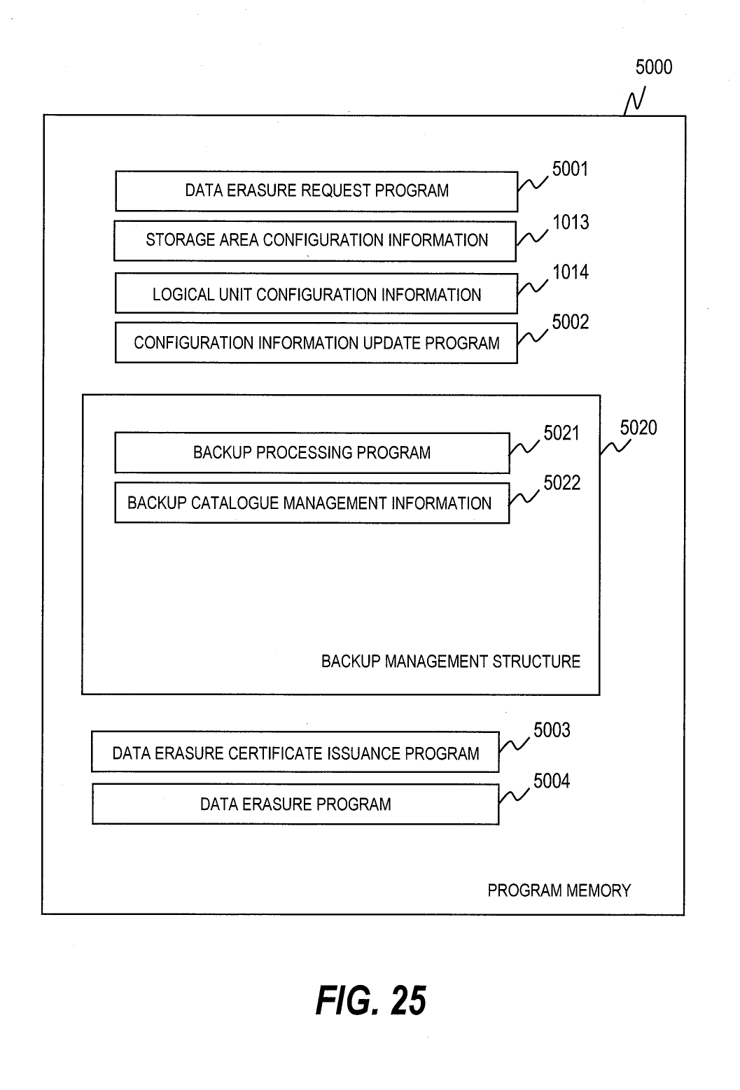

FIG. 25 shows examples of a control program and control information stored in a program memory 5000 of the management computer 500 according to the third embodiment of this invention.

The program memory 5000 of the management computer 500 stores a data erasure request program 5001, storage area configuration information 1013, logical unit configuration information 1014, a configuration information update program 5002, a backup management structure 5020, a data erasure certificate issuance program 5003, and a data erasure program 5004.

The data erasure request program 5001 is the program for requesting data erasure by the data erasure program 1001 or 5004 to the storage subsystem 100 and the tape library device 200 based on an input from an administrator.

The storage area configuration information 1013 and the logical unit configuration information 1014 are obtained from the storage subsystem 100 by executing the configuration information update program 5002. A procedure of updating configuration information by the configuration information update program 5002 is similar to that of the first embodiment of this invention shown in FIG. 11.

The data erasure certificate issuance program 5003 provides an erasure certificate to the administrator via the output interface 575 as in the case of the first embodiment of this invention.

The data erasure program 5004 overwrites the tape recoding medium 220 with dummy data such as zero data or random number data to erase residual magnetism from the tape recording medium 220, thereby completely inhibiting reading of data.

The backup management structure 5020 includes a program and information for managing or controlling an operation and a status of a backup system. Specifically, the backup management structure 5020 includes a backup process program 5021 and backup catalogue management information 5022.

The backup process program 5021 is the program for writing data stored in a storage area in the tape library device 200. The backup catalogue management information 5022 is management information of backup data stored in the tape recording medium 220 through a backup process executed by the backup process program 5021.

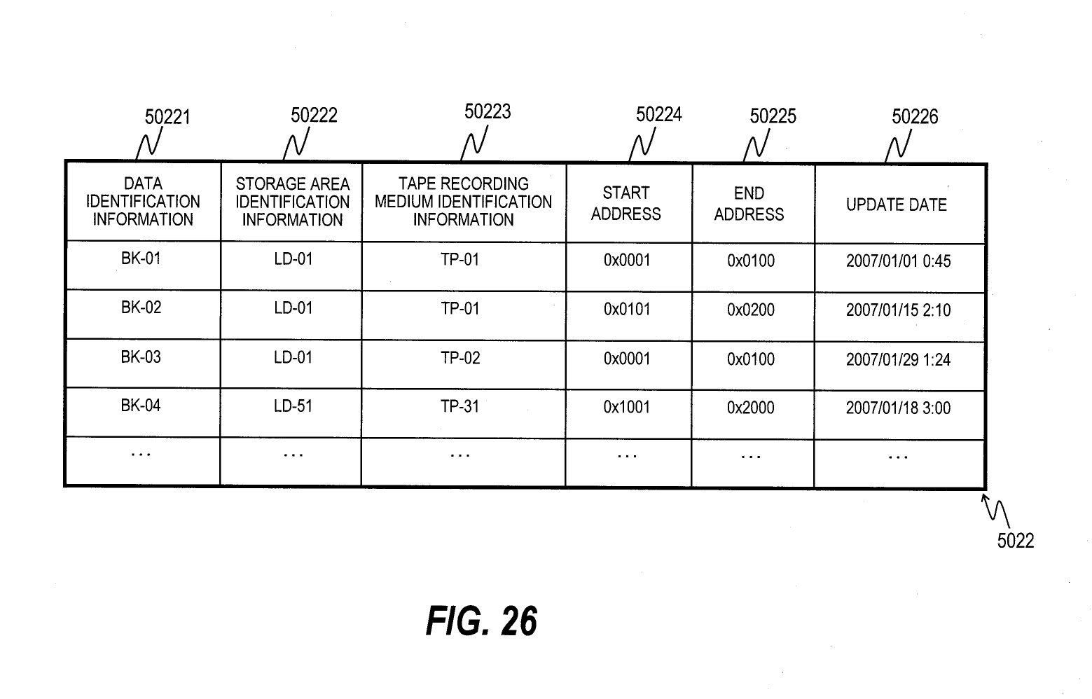

FIG. 26 shows an example of backup catalogue management information 5022 according to the third embodiment of this invention.

The backup catalogue management information 5022 contains data identification information 50221, storage area identification information 50222, tape recording medium identification information 50223, a start address 50224, an end address 50225, and an update date 50226.

In the data identification information 50221, an identifier for identifying backup data is stored. In the storage area identification information 50222, an identifier of a storage area in which created backup data has been stored is stored. Backup data of the storage area identified by the storage area identification information 50222 corresponds to data identified by the data identification information 50221.

In the tape recording medium identification information 50223, an identifier for identifying the tape recording medium 220 in which the backup data has been stored is stored. Address space defined by the start address 50224 and the end address 50225 corresponds to address space storing relevant data in the tape recording medium 220 identified by the tape recording medium identification information 50223. In the update date 50226, a date of creating or updating backup data is stored.

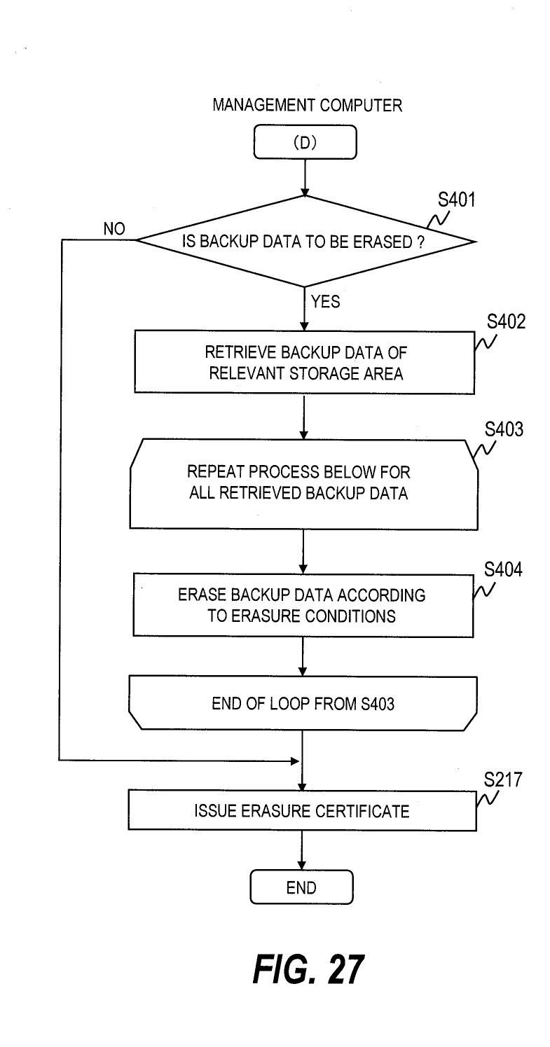

FIG. 27 is a flowchart showing a data erasure processing procedure of a storage area according to the third embodiment of this invention.

A procedure of erasing data stored in a designated storage area shown in FIG. 14 and a procedure of resuming data writing to the storage subsystem 100 from the host computer 300 shown in FIG. 15 are similar to those of the first embodiment of this invention. The data erasure process is executed by executing a data erasure request program 5001 via a processing unit 580 of the management computer 500.

The procedure shown in the flowchart of FIG. 27 is executed after the process of the step S210 of FIG. 15. Specifically, search is carried out in the storage area catalogue management information 5012 to obtain a storage area of an erasure target, thereby erasing data of the storage area of the erasure target.

The processing unit 580 of the management computer 500 judges whether entered data erasure conditions include an instruction of erasing backup data recorded in the tape recording medium 220 (step S401).

In the case of erasing the backup data recorded in the tape recording medium 220 (result of the step S401 is “Yes”), the processing unit 580 of the management computer 500 refers to the backup catalogue management information 5022 to retrieve and obtain all backup data of the designated erasure target storage area (step S402).

The processing unit 580 of the management computer 500 executes a process below for all the obtained backup data (step S403).

The processing unit 580 of the management computer 500 executes the tape erasure program 5004 to instruct the tape library device 200 to load the tape recording medium 220 storing the backup data. Then, the processing unit 580 erases the backup data stored from the start address 50224 to the end address 50225 of the tape recording medium 220, and removes residual magnetism (step S404).

A flow of the data erasure process of the third embodiment of this invention will be described more specifically based on the aforementioned procedure.

A case where an administrator instructs erasure of a storage area “LD-01” as a storage area of an erasure target in the process of the step S201 of FIG. 14 will be described. It is presumed that erasure of backup data of the “LD-01” is instructed by erasure conditions entered in the step S201.

After the erasure of the storage area “LD-01” in the step S206, the processing unit 580 of the management computer 500 refers to the backup catalogue management information 5022 to obtain information of backup data of the storage area “LD-01” (step S302). Referring to the backup catalogue management information 5022 shown in FIG. 26, backup data in which the storage area identification information 50222 is “LD-01” are “BK-01”, “BK-02”, and “BK-03”.

The processing unit 580 of the management computer 500 executes the data erasure program 5004 to execute a data erasure process of the obtained backup data (step S404). Specifically, for the “BK-01”, the tape library device 200 is first instructed to load a tape recording medium “TP-01”, and executes an erasure process for areas of addresses “0×0001” to “0×0100”. Similarly, an erasure process is executed for the “BK-02” and the “BK-03”.

According to the third embodiment of this invention, in the case of erasing data of the designated storage area, even if a copy of the data has been stored in a storage device such as a tape recording medium, related data such as backup data can be erased.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a storage system;
a host computer coupled to the storage system via a network; and
a management computer having access to the storage system and the host computer, wherein:
the storage system comprises a first interface coupled to the network, a first processor coupled to the first interface, and a first memory coupled to the first processor, and provides a first volume for reading/writing data to the host computer;
the management computer comprises a second interface coupled to the network, a second processor coupled to the second interface, and a second memory coupled to the second processor that stores catalogue information including correspondence between the first volume and a second volume for storing a copy of data stored in the first volume;
the management computer requests erasure of the data stored in the first volume to the storage system upon reception of an erasure request of data stored in the first volume;
the storage system erases the data stored in the first volume based on the erasure request of the data stored in the first volume;
the management computer specifies the second volume storing a copy of the data stored in the first volume based on the catalogue information, and requests erasure of data stored in the specified second volume to the storage system; and
the storage system erases the data stored in the specified second volume.

2. The computer system according to claim 1, wherein:
the catalogue information further includes information of a third volume which stores an old copy of the data stored in the first volume;
the management computer specifies the third volume corresponding to the first volume for which data erasure is requested based on the catalogue information; and
the storage system erases data stored in the specified third volume.

3. The computer system according to claim 1, wherein the storage system erases the data stored in the first volume and the second volume by overwriting to the first volume and the second volume with predetermined dummy data a plurality of times.

4. The computer system according to claim 1, wherein the management computer outputs a notification of the erasure of the data stored in the first volume and the second volume upon erasure of the data stored in the first volume and the second volume.

5. The computer system according to claim 1, wherein:
the storage system further provides a fourth volume for storing a copy of the data stored in the second volume; and
the storage system erases data stored in the fourth volume upon erasure of the data stored in the second volume.

6. The computer system according to claim 1, further comprising a second storage system coupled to the storage system,
wherein the second volume is provided by the second storage system.

7. The computer system according to claim 1, wherein:
in a case of setting for stopping reading/writing data to the first volume and setting for reading/writing data to the second volume instead of the first volume, the management computer requests erasure of the data stored in the second volume to the storage system upon reception of an erasure request of the data stored in the second volume;
the storage system erases the data stored in the second volume based on the erasure request of the data stored in the second volume;
the management computer specifies the first volume corresponding to the second volume based on the catalogue information; and requests erasure of the data stored in the specified first volume to the storage system; and
the storage system erases the data stored in the specified first volume.

8. A management computer comprising:
a network interface coupled to a host computer via a network and coupled to a storage system via a network;
a processor coupled to the network interface; and
a memory coupled to the processor, wherein:
the memory stores catalogue information containing correspondence between a first volume provided as a storage area to the host computer by the storage system and a second volume for storing a copy of data stored in the first volume; and
the processor requests via the network interface erasure of the data stored in the first volume to the storage system upon reception of an erasure request of data stored in the first volume, specifies the second volume storing a copy of the data stored in the first volume based on the catalogue information; and requests via the network interface erasure of data stored in the specified second volume to the storage system.

9. The management computer according to claim 8, wherein:
the catalogue information further includes information of a third volume which stores an old copy of the data stored in the first volume;
the processor specifies the third volume corresponding to the first volume for which data erasure is requested based on the catalogue information; and requests erasure of data stored in the specified third volume to the storage system.

10. The management computer according to claim 8, wherein the processor outputs a notification of the erasure of the data stored in the first volume and the second volume upon erasure of the data stored in the first volume and the second volume.

11. In a computer system including a host computer, a storage system coupled to the host computer via a network, a management computer having access to the storage system and the host computer via a network, a data management method for managing data stored in the storage system installed in a computer system,
the data management method comprising the steps of:
providing, by the storage system, a first volume for reading/writing data to the host computer;
copying, by the storage system, data to a second volume from the first volume,
storing catalogue information including correspondence between the first volume and a second volume for storing a copy of data stored in the first volume,
requesting, by the management computer, erasure of the data stored in the first volume to the storage system upon reception of an erasure request of data stored in the first volume;
erasing, by the storage system, the data stored in the first volume based on the erasure request of the data stored in the first volume;
specifying, by the management computer, the second volume for storing a copy of the data stored in the first volume based on the catalogue information;
requesting, by the management computer, erasure of data stored in the specified second volume to the storage system; and
erasing, by the storage system, the data stored in the specified second volume.

12. The data management method according to claim 11, wherein:
the catalogue information further includes information of a third volume which stores an old copy of the data stored in the first volume; and
the data management method further comprises the steps of:
specifying, by the management computer, the third volume corresponding to the first volume for which data erasure is requested based on the catalogue information; and
erasing, by the storage system, data stored in the specified third volume.

13. The data management method according to claim 11, wherein:
the process of erasing the data stored in the first volume is executed by overwriting to the first volume with predetermined dummy data a plurality of times; and
the process of erasing the data stored in the second volume is executed by overwriting to the second volume with predetermined dummy data a plurality of times.

14. The data management method according to claim 11, further comprises the step of outputting, by the management computer, a notification of the erasure of the data stored in the first volume and the second volume upon erasure of the data stored in the first volume and the second volume.

15. The data management method according to claim 11, wherein:
the storage system further provides a fourth volume for storing a copy of the data stored in the second volume; and
the data management method further comprises the step of erasing, by the first processor, data stored in the fourth volume upon erasure of the data stored in the second volume.

16. The data management method according to claim 11, wherein:
the computer system further comprises a second storage system coupled to the storage system; and
the second storage system provides the second volume.

17. The data management method according to claim 11, further comprising the steps of:
requesting, by the management computer, erasure of the data stored in the second volume to the storage system upon reception of an erasure request of the data stored in the second volume, and in a case of setting for stopping reading/writing data to the first volume and setting reading/writing data in the second volume instead of the first volume;
erasing, by the management computer, the data stored in the second volume based on the erasure request of the data stored in the second volume;
specifying, by the management computer, the first volume corresponding to the second volume based on the catalogue information,
requesting, by the management computer, erasure of the data stored in the specified first volume to the storage system, and
erasing, by the storage system, the data stored in the specified first volume.
